(19) United States
(12) Patent Application Publication
(10) Pub. No.: US 2026/0068950 A1
(43) Pub. Date: Mar. 12, 2026

(54) AEROSOL-GENERATING DEVICE WITH USAGE LIMITATION

(71) Applicant: Philip Morris Products S.A., Neuchatel (CH)

(72) Inventors: Michel BESSANT, Neuchatel (CH); Riccardo RIVA REGGIORI, Lausanne (CH); Valerio OLIANA, Pully (CH); Stefanos KONANDREAS, Geneva (CH); Bogdan PERJU, Chamby (CH)

(73) Assignee: Philip Morris Products S.A., Neuchatel (CH)

(21) Appl. No.: 19/105,542

(22) PCT Filed: Sep. 1, 2023
(86) PCT No.: PCT/EP2023/074071

§ 371 Date: Feb. 21, 2025

(30) Foreign Application Priority Data
Sep. 2, 2022 (EP) 22386060.2

(51) Int. Cl. A24F 40/53; A24F 40/60; A24F 40/90; H02J 7/00

(52) U.S. Cl. CPC A24F 40/53; A24F 40/60; A24F 40/90; H02J 7/80

(57) ABSTRACT

An aerosol-generating device is provided, including: device control circuitry and an energy storage configured to supply electrical energy to the circuitry for generating aerosol from an aerosol-generating article, the circuitry being configured to: receive a limitation parameter indicative of a limitation to use the device to generate aerosol, control the energy storage based on the limitation parameter, such that operation of the device by a user to generate aerosol is limited in accordance with the parameter, determine actual values of operational parameters and compare the values to predefined values of the operational parameters, and one or more of terminate a charging cycle of the energy storage, signal completion of a charging cycle, signal an empty energy storage to the user, trigger re-charging of the energy storage, request re-charging of the energy storage, disable the device, and enable the device based on the comparison.

The present disclosure generally relates to the field of aerosol-generating devices and systems for generating aerosol. In particular, the present disclosure relates to electronic aerosol-generating devices and systems configured to generate aerosol based on heating at least a part of an aerosol-generating article or substrate. The present disclosure further relates to use of such aerosol-generating device or system, to a method of operating such aerosol-generating device or system, to a corresponding computer program and to a non-transitory computer-readable medium storing such computer program.

Aerosol-generating devices are typically designed as handheld devices that can be used by a user for consuming or experiencing, for instance in one or more usage sessions, aerosol generated by heating an aerosol-generating substrate or an aerosol-generating article comprising such substrate. It will be appreciated that aerosol-generating devices can generate aerosol by other means, such as for example by vibrating, by spraying or other means.

Exemplary aerosol-generating substrates can comprise solid substrate material, such as tobacco material or tobacco cast leaves (“TCL”) material. The substrate material can, for example, be assembled, often with other elements or components, to form a substantially stick-shaped aerosol-generating article. Such a stick or aerosol-generating article can be configured in shape and size to be inserted at least partially into the aerosol-generating device, which, for example, can comprise a heating element for heating the aerosol-generating article and/or the aerosol-generating substrate. Alternatively or additionally, aerosol-generating substrates can comprise one or more liquids and/or solids, which can for example be supplied to the aerosol-generating device in the form of a cartridge or container. Exemplary aerosol-generating articles can comprise a cartridge or container that contains or is fillable with the liquid and/or solid substrate, which can be vaporized during aerosol consumption by the user based on heating the substrate. Usually, such cartridge can be coupled to, attached to or at least partially inserted into the aerosol-generating device. Alternatively, the cartridge may be fixedly mounted to the aerosol-generating device and refilled by inserting liquid and/or solid substrate material into the cartridge.

For generating aerosol during use or consumption, a user usually actuates a user interface of the aerosol-generating device, thereby triggering supply of one or more aerosol-generating means or aerosol generators, such as one or more heating elements or heat sources, with electrical energy, for example to heat at least a portion of the aerosol-generating substrate or article. At least a part of the aerosol-generating means or aerosol generator, for example at least a part of the heating element, can be arranged in the aerosol-generating device. Alternatively or additionally, at least a part of the aerosol-generating means or aerosol generator, for example at least a part of the heating element, can be arranged in the aerosol-generating article.

Exemplary heating elements can be based on one or more of resistive heating, inductive heating and microwave heating using electrical energy supplied via, drawn from or stored in an energy storage of the aerosol-generating device. Exemplary energy storages can include one or more batteries, one or more capacitors, one or more supercapacitors, one or more accumulators or other types of energy storage.

Alternatively or additionally, the aerosol-generating device may be configured to supply electrical energy to one or more other aerosol-generating means, aerosol engines or aerosol generators to generate aerosol. For example, the aerosol-generating device and/or aerosol-generating article may comprise one or more vibrating elements, one or more vibrating meshes, one or more spraying devices, or other means for generating aerosol.

In particular when the aerosol-generating device is frequently used or operated to generate aerosol, a quality of an energy storage or its capability to store electrical energy may decrease over time and after a certain lifetime or service-life of the energy storage, the aerosol-generating device or at least the energy storage may be replaced. For example, the lifetime or service-life of the energy storage, and thus possibly the lifetime or service-life of the aerosol-generating device, may be adversely affected by excessive charging and/or discharging of the energy storage, which may be caused by over usage or excessive usage of the aerosol-generating device by a user.

It may, therefore, be desirable to provide for an improved aerosol-generating device or system, for example an aerosol-generating device or system having an improved lifetime or service-life.

This is achieved by the subject-matter of the independent claims. Optional features are provided by the dependent claims and by the following description.

According to an aspect of the disclosure, there is provided an aerosol-generating device configured to generate aerosol. The aerosol-generating device comprises device control circuitry and an energy storage configured to supply electrical energy to the device control circuitry for generating aerosol from an aerosol-generating article. The device control circuitry may optionally be operatively coupled to the energy storage. The device control circuitry is configured to receive a limitation parameter indicative of a limitation to use the aerosol-generating device to generate aerosol. Further, the device control circuitry is configured to control the energy storage based on the limitation parameter, such that operation of the aerosol-generating device by a user to generate aerosol is limited in accordance with the limitation parameter.

The energy storage and/or device control circuitry may be configured to supply electrical energy to at least one aerosol-generating means or at least one aerosol generator for generating aerosol from at least a portion of an aerosol-generating article couplable to the aerosol-generating device. Exemplary aerosol generators or means may include one or more heating elements, one or more heat sources, one or more vibrating elements, one or more vibrating meshes, and one or more spraying devices.

For example, the energy storage and/or device control circuitry may be configured to supply electrical energy to at least one heating element to generate aerosol from an aerosol-generating article couplable to the aerosol-generating device, for example based on heating at least a portion of the aerosol-generating article.

The aerosol-generating device of the present disclosure may particularly refer to or denote an electronic aerosol-generating device. Further, exemplary aerosol-generating articles can be stick-like formed and at least partly inserted into the aerosol-generating device. Alternative exemplary aerosol-generating articles can comprise a container or cartridge, which can be fixedly attached or detachably coupled to the aerosol-generating device. Typically, a liquid, solid or a mixture of solid and liquid aerosol-generating substrate is contained in or can be inserted into such aerosol-generating article and heated to generate aerosol. Any such as well as other forms and designs of aerosol-generating articles can be used with the aerosol-generating device and system of the present disclosure.

Generally, the device control circuitry may be configured to control one or more device functions of the aerosol-generating device. In particular, the device control circuitry may include one or more processors configured to receive and/or process the limitation parameter. The device control circuitry may be configured to operatively control the aerosol-generating device and/or its energy storage based on the limitation parameter. Optionally, operative control of one or more device functions and/or of the energy storage may include generating and/or providing one or more control signals to one or more components of the aerosol-generating device, such as for example the energy storage.

In an exemplary configuration, the device control circuitry may be configured to receive the limitation parameter based on retrieving or obtaining the limitation parameter from a data storage or memory of the aerosol-generating device. Alternatively or additionally, the limitation parameter may be received or obtained from a computing device and/or a companion device communicatively couplable to the aerosol-generating device. As will be further described hereinbelow, exemplary computing devices communicatively couplable to the aerosol-generating device can include a server, a server network, a smart phone, a mobile device, a smart device or other types of computing devices.

As used herein, the limitation parameter may include operational data or information for operatively controlling the aerosol-generating device and/or its energy storage, for example based on processing the limitation parameter with the device control circuitry. The limitation parameter may be indicative of a limitation to use or operate the aerosol-generating device to generate aerosol by a user. The limitation to use the aerosol-generating device may refer to or denote a restriction or limit to generate aerosol by a user using the aerosol-generating device. In other words, the limitation parameter may be indicative or representative of a consumption limit or operation limit that limits use or operation of the device to generate aerosol, for example thereby preventing further aerosol consumption by the user.

Generally, the limitation parameter may correlate with, be convertible to and/or be indicative of one or more operational parameters related to, associated with and/or involved in operation of the aerosol-generating device to generate aerosol. This may include one or more operational parameters directly or indirectly associated with the generation of aerosol by the aerosol-generating device. For example, the limitation parameter may be time-based, energy-based and/or usage- or consumption-based. Alternatively or additionally, the limitation parameter may infer a limitation to use the aerosol-generating device, which limitation may be one or more of time-based, energy-based, and usage-based. These and other aspects will be further described in more detail herein.

Usually, aerosol-generating devices can be operated by users to consume or experience aerosol in a plurality of usage sessions using one or more aerosol-generating articles, wherein the energy storage may be re-charged multiple times in multiple charging cycles. Therein, a charging cycle may refer to a process, in which the energy storage may be charged from a minimum energy level or “depleted state” to a maximum energy level or “fully charged” state. As a consequence of charging and discharging the energy storage, a quality of the energy storage or its capability to store electrical energy may decrease or may be adversely affected over time. After a certain lifetime or service-life of the energy storage, the aerosol-generating device or at least the energy storage may be replaced to ensure full functionality of the aerosol-generating device, for example to ensure that a sufficient amount of electrical energy can be stored in the energy storage to heat the heating element to generate aerosol. Excessive charging and/or discharging of the energy storage, which may be caused by over usage or excessive usage of the aerosol-generating device by a user, may further adversely affect the lifetime or service-life of the energy storage and aerosol-generating device.

Such adverse affection of the lifetime or service-life of the energy storage may advantageously be avoided or at least mitigated by the aerosol-generating device according to the present disclosure, and specifically by limiting use of the aerosol-generating device based on the limitation parameter. In other words, limiting use or operation of the aerosol-generating device by the user to generate aerosol based on the limitation parameter may advantageously allow to increase or improve a lifetime or service-life of the energy storage, and in turn may allow to improve or increase a lifetime or service-life of the aerosol-generating device. Due to the increased lifetime, also sustainability of the aerosol-generating device may be significantly improved, and an environmental impact, for example caused by disposal of the aerosol-generating device or energy storage, may be reduced.

As used herein, the energy storage of the aerosol-generating device may be configured to store or may store electrical energy that can be supplied to the at least one heating element to generate aerosol. Optionally, the energy storage may be re-chargeable, for example by connecting the aerosol-generating device to a power supply or a companion device. For example, the energy storage may be re-charged by connecting the aerosol-generating device to the companion device or power supply via cable or inductive coupling. It is noted that the aerosol-generating device can comprise a plurality of energy storages. Accordingly, any reference to a single energy storage hereinabove and hereinbelow includes a plurality of energy storages.

In an example, the energy storage may include one or more batteries, accumulators, capacitors, supercapacitors, or other types of energy storage for storing electrical energy, such as for example an energy storage configured to store potential energy associated with a change in configuration of internal chemical elements or molecules of the energy storage. Also a combination of any of the aforementioned types of energy storages can be implemented in the aerosol-generating device of the present disclosure.

In an example, the aerosol-generating device may comprise a user interface actuatable by the user to activate or operate the aerosol-generating device to generate aerosol. Exemplary user interfaces may include a button, a switch, a touch display, an acoustic interface, a gesture control interface, or a combination thereof. When the limitation to use the aerosol-generating device indicated by the limitation parameter is not reached, the device control circuitry may be operable to receive one or more user inputs from the user interface and operate or power the heating element, respectively a heating circuit including the heating element, to generate aerosol in accordance with the one or more user inputs. In particular, in response to an actuation of the user interface, electrical energy may be supplied to the at least one heating element to heat at least a part of an aerosol-generating article and generate aerosol, while the limitation or a condition to use the aerosol-generating device indicated by the limitation parameter is not reached or met Upon reaching the limitation to use the aerosol-generating device indicated by the limitation parameter, the device control circuitry may configure the energy storage to limit or prevent aerosol generation, for example irrespective of one or more user inputs received at the user interface and indicating a user's request to generate aerosol.

Alternatively or additionally, upon reaching the limitation to use the aerosol-generating device indicated by the limitation parameter, the device control circuitry may configure the aerosol-generating device and/or the energy storage into an inoperable state, in which the device is inoperable by the user to generate aerosol. Alternatively or additionally, the device control circuitry may configure the aerosol-generating device and/or the energy storage into an operable state, in which the aerosol-generating device is operable by the user to generate aerosol, if or when the limitation to use the aerosol-generating device indicated by the limitation parameter is not reached.

In an example, the limitation parameter may be indicative of an amount of electrical energy available to the user to generate aerosol. Alternatively or additionally, the device control circuitry may be configured to control the energy storage based on the limitation parameter, such that the energy available to the user to generate aerosol may be limited in accordance with the limitation parameter. Alternatively or additionally, the device control circuitry may be configured to control an amount of electrical energy available to the user to generate aerosol based on the limitation parameter. The device control circuitry may be configured to control one or both charging and discharging of the energy storage to limit use of the device to generate aerosol in accordance with the amount of electrical energy available to the user indicated by the limitation parameter.

As used herein, the amount of electrical energy available to the user to generate aerosol may refer to or denote the amount of electrical energy that can be drawn from the energy storage and/or that can be supplied to the heating element, for example in response to one or more user inputs requesting aerosol generation or consumption in one or more usage sessions. By associating the limitation parameter to the amount of electrical energy available to generate aerosol, aerosol consumption or generation may be effectively limited or prevented since the heating element or a heating circuit may not be powered upon reaching the limitation to use the device indicated by the limitation parameter. Also, excessive charging and discharging may be effectively avoided by limiting the amount of electrical energy available, thereby increasing service-life or lifetime of the energy storage and aerosol-generating device.

A usage session may be a finite usage session; that is a usage session having a start and an end. The duration of the usage session as measured by time may be influenced by use during the usage session. The duration of the usage session may have a maximum duration determined by a maximum time from the start of the usage session. The duration of the usage session may be less than the maximum time if one or more monitored parameters reaches a predetermined threshold before the maximum time from the start of the usage session. By way of example, the one or more monitored parameters may comprise one or more of: i) a cumulative puff count of a series of puffs drawn by a user since the start of the usage session, and ii) a cumulative volume of aerosol evolved from the aerosol-forming substrate or article since the start of the usage session.

The amount of electrical energy available may be indicated or defined by the limitation parameter on any suitable absolute or relative scale. For instance, the limitation parameter may be indicative of or be given as a fraction, a percentage or part of a nominal capacity or nominal amount of electrical energy storable in the energy storage. Alternatively or additionally, the amount of electrical energy available to the user may be given in absolute values, for example based on specifying one or more of a current, a voltage, an operation time or other operational parameters. Alternatively or additionally, the limitation parameter may indirectly limit the amount of energy available to the user, for example based on specifying or defining a usage-limit in terms of a number of usage sessions the aerosol-generating device can be used, a number of aerosol-generating articles that can be used or consumed with the device, and a number of puffs or inhalations that a user can take using the aerosol-generating device.

In an example, the limitation parameter may be indicative of one or more predefined values for one or more operational parameters related to, associated with and/or involved in operation of the aerosol-generating device to generate aerosol. For instance, the one or more operational parameters may be involved in supplying electrical energy from the energy storage to the heating element to generate aerosol. Generally, the one or more operational parameters may include one or more operational parameters related to charging of the energy storage and/or one or more operational parameters related to discharging of the energy storage.

It should be noted that the limitation parameter can include a plurality of elements, each indicative of at least one predefined value of at least one operational parameter related to, associated with and/or involved in operation of the aerosol-generating device to generate aerosol. Alternatively or additionally, a plurality of limitation parameters, each indicative of at least one predefined value of at least one operational parameter may be utilized.

In an exemplary implementation, a predefined value of an operational parameter may refer to, include, or be indicative of a threshold or threshold value for said operational parameter.

For example, the device control circuitry may be configured to monitor the one or more operational parameters during use or operation of the aerosol-generating device. Alternatively or additionally, the device control circuitry may be configured to determine whether one or more predefined or threshold values for the one or more operational parameters indicated by the limitation parameter are reached. This may include a comparison of one or more values of one or more monitored operational parameters with the one or more predefined or threshold values for the one or more operational parameters indicated by the limitation parameter.

By way of example, the limitation parameter may be indicative of one or more of the following operational parameters: a predefined output voltage of the energy storage, a predefined charging energy suppliable to the energy storage to re-charge the energy storage, a predefined potential energy of the energy storage associated with a change in configuration of internal chemical elements of the energy storage, and a predefined number of charging cycles the energy storage is chargeable. Other exemplary operational parameters, directly or indirectly related to use or operation of the aerosol-generating device to generate aerosol, may be a predefined number of usage sessions the aerosol-generating device can be used to generate aerosol, a predefined operation time the aerosol-generating device can be used to generate aerosol, a predefined number of aerosol-generating articles that can be used or consumed with the aerosol-generating device, a predefined number of puffs or inhalations the user can take, a predefined amount of aerosol-generating substrate or article usable with the aerosol-generating device, a predefined range of dates, for example including a start date and an end date, and an amount of energy drawable from the energy storage for aerosol generation. Any one or more of the aforementioned as well as other operational parameters may be considered or reflected by the limitation parameter and used to infer the usage limitation to the aerosol-generating device.

In an example, the device control circuitry may be configured to determine, based on the limitation parameter, one or more of a predefined output voltage of the energy storage, a predefined charging energy suppliable to the energy storage, a predefined potential energy of the energy storage associated with a change in configuration of internal chemical elements of the energy storage, and a predefined number of charging cycles the energy storage is chargeable.

Optionally, determining a predefined parameter based on the limitation parameter may include deriving a predefined or threshold value for said parameter from the limitation parameter. For example, the device control circuitry may process the limitation parameter to compute or calculate one or more predefined or threshold values for one or more operational parameters, such as for example a predefined or threshold value for the output voltage, a predefined or threshold value for the charging energy suppliable to the energy storage, a predefined or threshold value for the potential energy of the energy storage associated with a change in configuration of internal chemical elements of the energy storage, and a predefined or threshold number of charging cycles the energy storage is chargeable. Other predefined or threshold values for other operational parameters may be determined instead or in addition based on the limitation parameter, as described in more detail hereinabove and hereinbelow.

Alternatively or additionally, determining a predefined parameter based on the limitation parameter may include determining whether one or more values of one or more operational parameter corresponds to, matches and/or equals one or more predefined or threshold parameter values as indicated or defined by the limitation parameter.

Generally, one or more predefined parameter values or threshold parameter values for one or more operational parameters may be indicated by the limitation parameter, and optionally derived therefrom by the device control circuitry. Exemplary and non-limiting predefined parameters or threshold parameter values indicated by and/or derivable from the limitation parameter are a minimum output voltage of the energy storage, a maximum charging energy suppliable to the energy storage, a maximum charging time, a maximum charging current, and a maximum charging voltage of the energy storage. Other exemplary and non-limiting threshold values that can be defined by the limitation parameter may include one or more of a maximum decrease in output voltage of the energy storage, a potential energy of the energy storage associated with a change in configuration of internal chemical elements of the energy storage, a maximum of potential energy of the energy storage associated with a change in configuration of internal chemical elements of the energy storage, a maximum number of charging cycles the energy storage is chargeable, a maximum operation time the aerosol-generating device can be used to generate aerosol, a maximum range of dates the aerosol-generating device can be used to generate aerosol, for example including a start date and an end date or a duration, a maximum number or amount of aerosol-generating articles that can be used or consumed with the aerosol-generating device, a maximum number of puffs or inhalations the user can take, a maximum amount of aerosol-generating substrate usable with the aerosol-generating device, and a maximum amount of energy drawable from the energy storage for aerosol generation.

In an example, the device control circuitry may be configured to limit use of the aerosol-generating device at an output voltage equal to or below the minimum output voltage indicated or defined by the limitation parameter. Therein, the minimum output voltage may optionally differ from a nominal minimum output voltage, such as a nominal output voltage according to nominal characteristics of the energy storage. Accordingly, discharging of the energy storage may be modified with respect to nominal characteristics of the energy storage to control the aerosol-generating device or energy storage based on the limitation parameter.

By way of example, the limitation parameter may indicate a minimum output voltage of the energy storage higher than a nominal output voltage of the energy storage. The device control circuitry may monitor, measure, track and/or determine the output voltage or an actual output voltage of the energy storage during use of the device and compare it to the minimum output voltage indicated by the limitation parameter. When the actual output voltage reaches or falls below the minimum output voltage, the device control circuitry may configure the device or energy storage into an inoperable state, in which no aerosol may be generated by the user. In this example, the amount of energy drawable from the energy storage by the user may be limited by the limitation parameter.

Alternatively or additionally, the device control circuitry may be configured to limit and/or control the amount of energy suppliable to, storable in and/or stored in the energy storage in one or more charging cycles. For example, the device control circuitry may be configured to control one or more charging parameters for charging or re-charging the energy storage, which may also be referred to herein as operational parameters related to charging the energy storage. Exemplary charging parameters controllable by the device control circuitry are a charging voltage, which may refer to the voltage applied at the energy storage during charging of the energy storage in one or more charging cycles, a charging current, which may refer to the current supplied to the energy storage during charging of the energy storage in one or more charging cycles, a charging time, which may refer to a time or time period the energy storage is charged in one or more charging cycles, and a number of charging cycles that can be performed. By way of example, the limitation parameter may be indicative of and/or define one or more of a maximum charging energy, a maximum charging current, a maximum charging voltage, a maximum charging time, and a maximum number of charging cycles. Optionally, the device control circuitry may derive one or more of the aforementioned threshold values from the limitation parameter.

During charging of the energy storage, one or more of the actual charging voltage, the actual charging energy, the actual charging current, the actual charging time, and an actual number of the charging cycle may be determined by the device control circuitry and compared to the corresponding one or more threshold values indicated by the limitation parameter. Upon reaching one or more of these threshold values, a charging or re-charging of the energy storage may be terminated or prohibited by the device control circuitry. Since one or more charging parameters defined by the limitation parameter may differ from corresponding nominal values, the energy storage may be charged with an amount of electrical energy less than the nominal maximum amount, which theoretically may be storable in the energy storage. Hence, the amount of electrical energy storable in the energy storage and thus the amount of energy usable by the user to generate aerosol may be effectively and reliable limited based on the limitation parameter. Also, excessive charging and discharging may be prevented, thereby effectively avoiding or at least reducing degradation of the energy storage.

As noted above, characteristics of one or more charging cycles may be modified based on the limitation parameter with respect to a nominal charging cycle of the energy storage. Therein, a charging cycle may refer to a process, in which the energy storage may be charged from a minimum energy level or “depleted state” to a maximum energy level or “fully charged” state. The modification with respect to the nominal charging cycle of the energy storage inferred by the limitation parameter may include one or both of a modification of the minimum energy level and a modification of the maximum energy level of one or more charging cycles. For example, a charging cycle may be altered, changed or modified based on the limitation parameter, such that a minimum energy level, where the energy storage is in the depleted state, may differ from a nominal minimum energy level of the energy storage or physically depleted state. Alternatively or additionally, a charging cycle may be altered, changed or modified based on the limitation parameter, such that a maximum energy level, where the energy storage is in the fully charged state, may differ from a nominal maximum energy level of the energy storage or a physically fully charged state.

In an exemplary implementation, the limitation parameter may be indicative of a predefined output voltage of the energy storage, wherein the predefined output voltage may be indicative of an open circuit voltage. For instance, the predefined output voltage may be indicative of an output voltage of the energy storage when the heating element is switched off or a heating circuit is open, such as during charging or when the aerosol-generating device is deactivated.

Alternatively or additionally, the predefined output voltage of the energy storage indicated by the limitation parameter may be indicative of a closed-circuit voltage of the energy storage. For instance, the predefined output voltage may be indicative of an output voltage of the energy storage when the heating element is switched on or a heating circuit is closed, such as during use of the aerosol-generating device for aerosol consumption.

In an example, the device control circuitry may be configured to control, based on the limitation parameter, an amount of electrical energy available to the user by controlling charging of the energy storage in one or more charging cycles of the energy storage. Alternatively or additionally, the device control circuitry may be configured to control a charging process and/or an amount of electrical energy suppliable to, storable in and/or stored in the energy storage in one or more charging cycles, such that an amount of energy drawable from the energy storage and/or suppliable to the heating element may be limited in accordance with the limitation parameter. Hence, degradation of the energy storage can be prevented and operation of the aerosol-generating device by the user to generate aerosol can be effectively limited in accordance with the amount of electrical energy storable in the energy storage.

In exemplary implementation, the device control circuitry may be configured to one or more of terminate a charging cycle of the energy storage, signal completion of a charging cycle, signal an empty energy storage to the user, trigger re-charging of the energy storage, request re-charging of the energy storage, disable the aerosol-generating device for aerosol generation, and enable the aerosol-generating device for aerosol generation based on the limitation parameter.

For example, the device control circuitry may be configured to determine one or more actual values of one or more operational parameters and compare the one or more actual values to one or more predefined values of the one or more operational parameters indicated or defined by the limitation parameter. Alternatively or additionally, the device control circuitry may be configured to one or more of terminate a charging cycle of the energy storage, signal completion of a charging cycle, signal an empty energy storage to the user, trigger re-charging of the energy storage, request re-charging of the energy storage, disable the aerosol-generating device for aerosol generation, and enable the aerosol-generating device for aerosol generation based on the comparison.

By way of example, the device control circuitry may be configured to monitor one or more operational parameters, which may include determining an actual or current value of the one or more operational parameters. Further, the device control circuitry may be configured to compare the one or more monitored or determined values of the one or more operational parameters with one or more predefined or threshold values of the one or more operational parameters as indicated by, defined by and/or derived from the limitation parameter. Upon determining that at least one of the actual values of at least one operational parameter corresponds to, matches and/or equals to at least one of the predefined or threshold values for said at least one operational parameter, the device control circuitry may be configured to one or more of terminate a charging cycle of the energy storage, signal completion of a charging cycle, signal an empty energy storage to the user, trigger re-charging of the energy storage, request re-charging of the energy storage, and disable the aerosol-generating device for aerosol generation. Alternatively or additionally, upon determining that predefined or threshold value is not reached, the device control circuitry may enable the aerosol-generating device for aerosol generation.

Accordingly, to control the amount of electrical energy storable in the energy storage, the device control circuitry may terminate a charging cycle and/or signal completion of a charging cycle, such that a predefined amount of electrical energy, as indicated or defined by the limitation parameter, may be available to the user to generate aerosol. Therein, the charging cycle may be terminated at an energy level below or equal to a nominal maximum energy level of the energy storage, for example a maximum capacity of the energy storage.

Alternatively or additionally, the device control circuitry may signal an empty energy storage to the user, trigger re-charging of the energy storage, and/or request re-charging of the energy storage, thereby controlling the amount of electrical energy drawable from the energy storage and/or available to the user for generating aerosol. Therein, re-charging of the energy storage may be triggered at an energy level equal to or above a fully depleted energy storage. Accordingly, re-charging of the energy storage may be initiated before the energy storage is completely empty or physically depleted, thereby limiting the amount of electrical energy available to the user to generate aerosol.

Alternatively or additionally, the aerosol-generating device may be deactivated or disabled for aerosol generation based on the limitation parameter. For instance, supply of electrical energy from the energy storage to the heating element or a heating circuit may be prohibited by the device control circuitry in accordance with or based on the limitation parameter. For example, the aerosol-generating device may be deactivated upon reaching the limitation to use the device indicated by the limitation parameter. Alternatively or additionally, the aerosol-generating device may be activated or enabled for aerosol generation or for further use in case the limitation to use the device indicated by the limitation parameter is not reached.

In yet another example, the limitation parameter may be indicative of a maximum charging energy suppliable to the energy storage for charging the energy storage, wherein the device control circuitry may be configured to control the charging energy supplied to the energy storage based on the maximum charging energy indicated by the limitation parameter. For instance, the device control circuitry may be configured to determine one or more actual values of the charging energy supplied to the energy storage during charging or re-charging of the energy storage and compare the determined one or more actual values of the charging energy to the maximum charging energy defined by the limitation parameter. Optionally, the actual value of the charging energy may be monitored or determined over time during charging of the energy storage, for example continuously or at discrete time instants. Further optionally, upon determining that the actual charging energy equals or exceeds the maximum charging energy, the device control circuitry may terminate a charging cycle, terminate charging of the energy storage and/or signal completion of a charging cycle to the user. For example, completion of a charging cycle may be signaled based on providing an acoustic, haptic and/or optical signal to the user via a user interface of the aerosol-generating device, a computing device and/or a companion device communicatively coupled to the aerosol-generating device. By limiting the amount of energy stored or storable in the energy storage based on the limitation parameter, the energy storage can be protected against excessive charging, while use of the device for aerosol consumption can be efficiently limited. Also, service-life of the energy storage and aerosol-generating device may be improved or increased.

In an example, the device control circuitry may be configured to control the charging energy based on controlling one or more of a charging time, a charging voltage, and a charging current of the energy storage. Therein, the charging time may refer to a time or time period the energy storage is supplied with charging voltage and charging current, for example during one or more constant current phases of a constant current-constant voltage charging sequence of a charging cycle. The charging current may refer to the current supplied to the energy storage during charging, for example during one or more constant current phases of a charging cycle. The charging voltage may refer to the voltage supplied to the energy storage during charging, for example during one or more constant current or constant voltage phases of a charging cycle. For example, one or more of the charging voltage, the charging current, and the charging time can be controlled, varied and/or kept constant by the device control circuitry during charging of the energy storage, such that a predefined amount of electrical energy, as indicated by the limitation parameter, can be stored in the energy storage.

In a further example, the device control circuitry may be configured to terminate a charging cycle of the energy storage, terminate charging of the energy storage and/or signal completion of a charging cycle to the user upon determining a charging energy supplied to the energy storage equal to or exceeding a maximum charging energy indicated by the limitation parameter. For example, the device control circuitry may determine one or both the charging current and the charging voltage and compute the charging energy supplied to the energy storage over the charging time until the supplied charging energy equals the predefined maximum charging energy.

Alternatively or additionally, the device control circuitry may be configured to terminate a charging cycle of the energy storage, terminate charging of the energy storage and/or signal completion of a charging cycle to the user upon determining one or more of a charging current, a charging time, and a charging voltage of the energy storage being equal to or exceeding one or more of a maximum charging current, a maximum charging time, and a maximum charging voltage indicated by the limitation parameter.

In yet another example, the limitation parameter may be indicative of a maximum number of charging cycles the energy storage is chargeable, wherein the device control circuitry may be configured to control an amount of electrical energy available to the user based on limiting a number of charging cycles of the energy storage in accordance with the limitation parameter. For instance, the device control circuitry may be configured to track or monitor an actual number of charging cycles, which may correspond to the number of times the energy storage has been charged from a minimum to a maximum energy level. The device control circuitry may optionally compare the determined actual number of charging cycles to the maximum number indicated by the limitation parameter. Further optionally, the device control circuitry may disable and/or deactivate the aerosol-generating device upon determining that the actual number of charging cycles reaches or exceeds the maximum number. By limiting the number of charging cycles, the number of times the aerosol-generating device can be used by the user to generate aerosol can be effectively and reliably limited, while also preventing wear of the energy storage.

In an exemplary configuration, the aerosol-generating device may comprise a data storage storing a plurality of predefined configurations of the energy storage associated with one or more predefined capacity levels of the energy storage, wherein the device control circuitry may be configured to select one of the plurality of predefined configurations based on the limitation parameter and to configure the energy storage into the selected configuration. Therein, a capacity level may refer to, correlate with and/or be associated with a particular amount of electrical energy storable and/or stored in the energy storage. The one or more predefined capacity levels may be given in relative values, for example as fraction, percentage or portion of a nominal capacity level of the energy storage. Alternatively, the capacity levels may be given as absolute capacity or energy levels.

According to an example, the aerosol-generating device may comprise an energy storage controller, wherein the device control circuitry may be configured to control the energy storage based on configuring the energy storage controller in accordance with the limitation parameter. For example, the device control circuitry may configure the energy storage and/or the energy storage controller into a selected configuration based on setting one or more of a maximum charging time, a maximum charging current, a maximum charging voltage, and a maximum number of charging cycles in the energy storage controller. This may allow to dynamically adjust the configuration of the energy storage in accordance with the limitation parameter, for example in case the limitation parameter changes over time or after a certain period of time.

As mentioned above, the device control circuitry may be configured to control, based on the limitation parameter, an amount of electrical energy available to the user based on controlling discharging of the energy storage in one or more charging cycles of the energy storage.

For example, the limitation parameter may be indicative of a maximum number of usage sessions the aerosol-generating device is operable or can be used by the user to generate aerosol, wherein the device control circuitry may be configured to one or more of disable the energy storage, signal an empty energy storage, trigger re-charging, and request re-charging of the energy storage upon determining a number of usage sessions the aerosol-generating device has been operated to generate aerosol being equal to or exceeding the maximum number of usage sessions indicated by the limitation parameter. In an example, the device control circuitry may determine, monitor and/or track the number of usage sessions or an actual number of usage sessions, which may correspond to the number of times the aerosol-generating device has been used by the user to generate aerosol, and compare the determined actual number of usage sessions to the maximum number of usage sessions indicated by the limitation parameter. When the maximum number of usage sessions is reached, the device control circuitry may disable the energy storage, signal an empty energy storage, trigger re-charging, and/or request re-charging of the energy storage, such that further use of the aerosol-generating device may be prohibited, for example until the limitation parameter is modified or the number of usage sessions is reset.

It should be noted that in each usage session a new aerosol-generating article may be used or the same aerosol-generating article may be used in multiple usage sessions. Hence, the number of usage sessions may be identical to the number of aerosol-generating articles or it may differ therefrom.

The aerosol-generating device may optionally comprise a counter for counting a number of usage sessions the aerosol-generating device has been used to generate aerosol. Further, the device control circuitry may be configured to control the energy storage based on comparing the number of usage sessions indicated by the counter with the maximum number of usage sessions indicated by the limitation parameter. Such counter may be implemented in hardware and/or software. For example, the counter may be implemented as a mechanical or electronic counter. Optionally, the counter may be configured to persistently store the number of usage sessions, for example to store the number of usage sessions irrespective of whether the counter is supplied with electrical energy. Based on such counter, the number of usage sessions may be reliably monitored and use of the device may be reliably limited in accordance with the limitation parameter.

Alternatively or additionally, the aerosol-generating device may optionally comprise a counter for counting a number or amount of aerosol-generating articles used with the aerosol-generating device. Further, the device control circuitry may be configured to control the energy storage based on comparing the number of aerosol-generating articles indicated by the counter with a maximum number of aerosol-generating articles indicated by the limitation parameter. Alternatively or additionally, a counter for counting a number of inhalations or puffs may be used.

In an exemplary implementation, the limitation parameter may be indicative of a predefined output voltage of the energy storage. Further, the device control circuitry may be configured to measure an output voltage of the energy storage and to compare the measured output voltage of the energy storage to the predefined output voltage indicated by the limitation parameter. The predefined output voltage may, for example, be indicative of or refer to a threshold output voltage or minimum output voltage of the energy storage. Therein, the output voltage or predefined output voltage may refer to an open circuit voltage or a closed-circuit voltage of the energy storage.

In a further example, the device control circuitry may be configured to one or more of disable the energy storage, signal an empty energy storage, trigger re-charging, and request re-charging of the energy storage upon determining the measured output voltage of the energy storage being equal to or falling below the predefined output voltage indicated by the limitation parameter. Accordingly, the device control circuitry may monitor or track the output voltage, compare the output voltage to the minimum output voltage, as indicated by the limitation parameter, and one or more of disable the energy storage, signal an empty energy storage, trigger re-charging, and request re-charging of the energy storage upon determining the measured output voltage of the energy storage being equal to or falling below the predefined output voltage indicated by the limitation parameter.

In yet another example, the device control circuitry may be configured to control a discharge rate of the energy storage based on the limitation parameter. For example, the limitation parameter may be indicative of a predefined or threshold discharge rate, and the device control circuitry may be configured to determine an actual discharge rate and compare it to the predefined discharge rate to control the amount of electrical energy available to the user for generating aerosol. Therein, the discharge rate may, for example, be given as a number of discharging cycles per given period of time, wherein a discharging cycle may refer to depletion of the energy storage from a maximum energy level to a minimum energy level of the energy storage.

In another exemplary implementation, the limitation parameter may be indicative of a fraction of a maximum amount of energy storable in the energy storage, wherein the device control circuitry may be configured to one or more of disable the energy storage, signal an empty energy storage, trigger re-charging, and request re-charging of the energy storage upon determining a decrease in energy stored in the energy storage equal or above the fraction of the maximum amount of energy storable indicated by the limitation parameter. For example, the fraction of the maximum amount of energy storable in the energy storage may correlate with and/or refer to a fraction of a nominal storage capacity or maximum nominal capacity of the energy storage. Further, the fraction may be given in absolute or relative values, for example as a percentage of the maximum nominal amount of energy that may be physically or theoretically stored in the energy storage. Accordingly, use of the aerosol-generating device to generate aerosol may be limited by limiting the amount of electrical energy that can be drawn from the energy storage and supplied to the heating element to generate aerosol.

In an example, the limitation parameter may be indicative of a particular percentage of the maximum or nominal amount of energy storable in the energy storage, and the device control circuitry may determine, monitor and/or track the energy drawn from the energy storage. Upon determining that the energy drawn from the energy storage equals or falls below the percentage indicated by the limitation parameter, the device control circuitry may configured to one or more of disable the energy storage, signal an empty energy storage, trigger re-charging, and request re-charging of the energy storage. Hence, only the particular percentage of energy may be used by the user to generate aerosol, and operation of the aerosol-generating device may be disabled if this particular percentage has been used, for example by forcing re-charging of the energy storage, although the energy storage may not be physically depleted completely.

In yet another example, the limitation parameter may be indicative of a maximum operation time the aerosol-generating device is operable by the user to generate aerosol, wherein the device control circuitry is configured to one or more of disable the energy storage, signal an empty energy storage, trigger re-charging, and request re-charging of the energy storage upon determining an operation time of the aerosol-generating device being equal to or exceeding the maximum operation time indicated by the limitation parameter. For example, an operation time of the aerosol-generating device, which may refer to the time the aerosol-generating device is operated by the user to generate aerosol in one or more usage sessions, may be determined, monitored and/or tracked by the device control circuitry. Further, the device control circuitry may compare the determined operation time to the maximum operation time indicated by the limitation parameter. Optionally, the device control circuitry may be configured to one or more of disable the energy storage, signal an empty energy storage, trigger re-charging, and request re-charging of the energy storage upon determining that the operation time of the aerosol-generating device equals or exceeds the maximum operation time indicated by the limitation parameter. Hence, use of the aerosol-generating device to generate aerosol may be reliably limited by limiting the time or time period the aerosol-generating device may be operated to generate aerosol.

Alternatively or additionally, the limitation parameter may be indicative of a time period the aerosol-generating device can be used to generate aerosol. For instance, the limitation parameter may be indicative of one or more of a start date, from which the device can be operated to generated aerosol, and an end date, until which the aerosol-generating device can be operated to generate aerosol. The start and/or end date may, for example, be given as day of a month of a particular year.

In yet another exemplary implementation, the limitation parameter may be indicative of a maximum number or amount of aerosol-generating articles the aerosol-generating device is usable by the user, wherein the device control circuitry may be configured to one or more of disable the energy storage, signal an empty energy storage, trigger re-charging, and request re-charging of the energy storage upon determining a number or amount of aerosol-generating articles used with the aerosol-generating device being equal to or exceeding the maximum number or amount of aerosol-generating articles indicated by the limitation parameter.

For example, the number or amount of aerosol-generating articles used with the aerosol-generating device for aerosol consumption may be monitored and/or tracked by the device control circuitry. Further, the device control circuitry may compare the determined number or amount of aerosol-generating articles to the maximum number or amount of aerosol-generating articles indicated by the limitation parameter. Optionally, the device control circuitry may be configured to one or more of disable the energy storage, signal an empty energy storage, trigger re-charging, and request re-charging of the energy storage upon determining that the number or amount of aerosol-generating articles equals or exceeds the maximum number or amount of aerosol-generating articles indicated by the limitation parameter. Hence, use of the aerosol-generating device to generate aerosol may be reliably limited by limiting the number or amount of aerosol-generating articles that can be used with the aerosol-generating device.

In an exemplary implementation, the device control circuitry may be configured to retrieve the limitation parameter from a data storage of the aerosol-generating device. In other words, the limitation parameter may be stored on a data storage of the aerosol-generating device. Optionally, retrieving the limitation parameter may include loading the limitation parameter from the data storage. Further optionally, a plurality of limitation parameters may be stored on the data storage, and one of the limitation parameters may be selected by the device control circuitry, for example based on a control signal received from a computing device or companion device communicatively coupled to the aerosol-generating device and/or based on one or more user inputs.

In an exemplary configuration, the aerosol-generating device may comprise a communication interface for communicatively coupling the aerosol-generating device to a computing device, wherein the limitation parameter may be received from the computing device via the communication interface. The communication interface may be configured for one or both wired and wireless communication with the computing device. For example, the communication interface may include one or more of a BUS interface, a cable interface, a Bluetooth interface, a Wireless Local Area Network interface, an infrared communication interface, a nearfield communication interface, an internet communication interface or any other suitable type of communication interface. Also, a plurality of computing devices may be communicatively coupled to the aerosol-generating device via the communication interface, for example using the same or different types of communication protocols.

In an example, the computing device includes at least one of a server and a mobile device. The server may also refer to a plurality of servers, for example a server network. Alternatively or additionally, the mobile device may refer to a smart phone, laptop, tablet, a wearable, a smart device or any other type of mobile computing device. The server and/or the mobile device may comprise a communication interface to communicatively couple the server and/or mobile device to the aerosol-generating device, for example to transmit the limitation parameter or a corresponding control signal to the aerosol-generating device.

Optionally, an application or software may be running on the server and/or mobile device, which may allow a user to define a limitation parameter, for example based on a user account of the user and/or based on an identification number of the aerosol-generating device, and to initiate transmission of the limitation parameter to the aerosol-generating device. It should be noted, however, that not necessarily the entire limitation parameter may be transmitted from the computing device to the aerosol-generating device, but only a corresponding control signal indicating a particular limitation parameter may be transmitted to the aerosol-generating device, which may then be loaded from a data storage of the aerosol-generating device.

In yet another exemplary configuration, the aerosol-generating device may comprise a user interface for receiving one or more user inputs, wherein the limitation parameter may be based on one or more user inputs received via the user interface of the aerosol-generating device. Accordingly, the limitation parameter may be user-definable via one or more user inputs.

In an example, the limitation parameter may be one or more of re-set, modified and updated based on a user input at the user interface. Alternatively or additionally, the limitation parameter may be one or more of re-set, modified and updated based on receiving a corresponding control signal from a computing device and/or companion device communicatively coupled to the aerosol-generating device.

In yet another example, the aerosol-generating device may be couplable, for example operatively and/or communicatively couplable, to a companion device for supplying electrical energy to the energy storage, wherein the limitation parameter may be received from the companion device upon coupling the aerosol-generating device to the companion device.

The companion device may be configured to at least partially receive the aerosol-generating device, for example for charging the aerosol-generating device and/or or for storing the aerosol-generating device. The aerosol-generating device may be configured for wireless charging by the companion device. For example, the companion device and the aerosol-generating device may be inductively coupled to charge the energy storage of the aerosol-generating device. Alternatively or additionally, the device control circuitry may be configured to establish an electrical connection with the companion device to charge the energy storage. Accordingly, the aerosol-generating device may be configured for being operatively coupled to the companion for charging the energy storage of the aerosol-generating device.

Alternatively or additionally, the companion device may comprise a communication interface for communicatively coupling the companion device to the aerosol-generating device, and for example for transmitting the limitation parameter or a corresponding control signal from the companion device to the aerosol-generating device. Optionally, communicative coupling of the aerosol-generating device and the companion device may be established upon operative coupling of the aerosol-generating device with the companion device to charge the aerosol-generating device, and vice versa.

In an example, the companion device may comprise a user interface for receiving one or more user inputs, for example to define the limitation parameter at the companion device, which may be transmitted to the aerosol-generating device. Alternatively or additionally, the companion device may be communicatively coupled to a computing device, such as a server or a mobile device, and the limitation parameter or a corresponding control signal may be received by the companion device from the computing device and then transmitted to the aerosol-generating device.

In an exemplary configuration, the aerosol-generating device may comprise at least a part of a heating element or a heating circuit coupled to the energy storage and configured to heat at least a portion of an aerosol-generating article. Accordingly, at least a part of the heating element and/or at least a part of a heating circuit may be integrated in the aerosol-generating device. For example, a resistive blade, a resonator, an exciter coil, a microwave generator or other type of heating element may be at least partially arranged and/or integrated in the aerosol-generating device.

Alternatively or additionally, the aerosol-generating device may be couplable to an aerosol-generating article, which includes at least a part of a heating element or heating circuit, wherein the energy storage may be configured to supply electrical energy to the at least one heating element of the aerosol-generating article to generate aerosol. For instance, a resistive blade, a resonator, an exciter coil, a microwave generator or other type of heating element may be at least partially arranged and/or integrated in the aerosol-generating device and powered or supplied with electrical energy drawn from the energy storage of the aerosol-generating device.

According to a further aspect of the disclosure, there is provided an aerosol-generating system comprising an aerosol-generating device, as described hereinabove and hereinbelow, and an aerosol-generating article couplable or coupled to the aerosol-generating device to generate aerosol from at least a portion of the aerosol-generating article (e.g. based on heating). Any disclosure presented hereinabove and hereinbelow with reference to the aerosol-generating device and/or the aerosol-generating article equally applies to the aerosol-generating system, and vice versa.

A further aspect of the disclosure relates to use of an aerosol-generating device and/or system, as described hereinabove and hereinbelow.

Yet another aspect of the disclosure relates to a method of operating an aerosol-generating device. The aerosol-generating device operated in accordance with the method may be an aerosol-generating device, as described hereinabove and hereinbelow. Accordingly, any feature function and/or element described hereinabove and hereinbelow with reference to the aerosol-generating device may be a feature, function, element and/or step of the method of operating the aerosol-generating device, and vice versa.

The aerosol-generating device operated in accordance with the method of the present disclosure includes an energy storage configured to supply electrical energy to the device control circuitry for generating aerosol from an aerosol-generating substrate. The method comprises at least following steps:
receiving, with the device control circuitry of the aerosol-generating device, a limitation parameter indicative of a limitation to use the aerosol-generating device to generate aerosol; and
configuring, with the device control circuitry of the aerosol-generating device, the energy storage based on the limitation parameter, thereby limiting operation of the aerosol-generating device by a user to generate aerosol in accordance with the limitation parameter.

The energy storage and/or device control circuitry may be configured to supply electrical energy to at least one aerosol-generating means or aerosol generator for generating aerosol from at least a portion of an aerosol-generating article couplable to the aerosol-generating device. Exemplary aerosol generators or means may include one or more heating elements, one or more heat sources, one or more vibrating elements, one or more vibrating meshes, and one or more spraying devices.

For example, the energy storage and/or device control circuitry may be configured to supply electrical energy to at least one heating element to generate aerosol from an aerosol-generating article couplable to the aerosol-generating device, for example based on heating at least a portion of the aerosol-generating article.

Alternatively or additionally, generating aerosol may be limited in accordance with the limitation parameter. Optionally, configuring the energy storage may include controlling the energy storage, such that operation of the aerosol-generating device to generate aerosol is limited in accordance with the limitation parameter.

In an example, the method may further comprise controlling an amount of electrical energy available to the user to generate aerosol based on the limitation parameter. Alternatively or additionally, configuring the energy storage may include controlling the amount of electrical energy available to the user to generate aerosol based on the limitation parameter.

In yet another example, the method may further comprise determining, based on the limitation parameter, one or more of a predefined output voltage of the energy storage, a predefined charging energy suppliable to the energy storage, a predefined potential energy of the energy storage associated with a change in configuration of internal chemical elements of the energy storage, and a predefined number of charging cycles the energy storage is chargeable. In a further example, the method may further comprise controlling, based on the limitation parameter, an amount of electrical energy available to the user by controlling one or more of charging and discharging of the energy storage in one or more charging cycles.

Optionally, the method may further comprise one or more of terminating a charging cycle of the energy storage, signaling completion of a charging cycle, signaling an empty energy storage to the user, triggering re-charging of the energy storage, requesting re-charging of the energy storage, disabling the aerosol-generating device for aerosol generation, and enabling the aerosol-generating device for aerosol generation based on the limitation parameter.

In yet another example, the method may further comprise determining one or more actual values of one or more operational parameters, comparing the one or more actual values to one or more predefined values of the one or more operational parameters indicated or defined by the limitation parameter, and one or more of terminating a charging cycle of the energy storage, signaling completion of a charging cycle, signaling an empty energy storage to the user, triggering re-charging of the energy storage, requesting re-charging of the energy storage, disabling the aerosol-generating device for aerosol generation, and enabling the aerosol-generating device for aerosol generation based on the comparing.

According to an example, the method may further comprise controlling a charging energy supplied to the energy storage based on controlling one or more of a charging time, a charging voltage, and a charging current of the energy storage.

Optionally, the method may further comprise determining, monitoring and/or tracking a charging energy the energy storage has been supplied with, and terminating a charging cycle of the energy storage in response to determining the charging energy being equal to or exceeding a maximum charging energy indicated by the limitation parameter.

Further optionally, the method may comprise terminating a charging cycle of the energy storage upon determining one or more of a charging current, a charging time and a charging voltage of the energy storage has been charged with being equal to or exceeding one or more of a maximum charging current, a maximum charging time and a maximum charging voltage indicated by the limitation parameter.

Alternatively or additionally, the method may further comprise limiting one or more of a number of charging cycles of the energy storage, a number of usage sessions the aerosol-generating device is usable to generate aerosol, a number or amount of aerosol-generating articles usable with the aerosol-generating device, and a number of inhalations or puffs the user can take in accordance with the limitation parameter, thereby controlling and/or limiting an amount of electrical energy available to the user.

In an example, the aerosol-generating device may further comprise a data storage storing a plurality of predefined configurations of the energy storage associated with one or more predefined capacity levels of the energy storage, and wherein the method may further comprise selecting one of the plurality of predefined configurations based on the limitation parameter and configuring the energy storage into the selected configuration.

Optionally, the method may further comprise configuring, by the device control circuitry, an energy storage controller in accordance with the limitation parameter.

In yet another example, the method may further comprise determining a number of usage sessions the aerosol-generating device has been operated to generate aerosol; and one or more of disabling the energy storage, signaling an empty energy storage, triggering re-charging, and requesting re-charging of the energy storage upon determining the number of usage sessions being equal to or exceeding the maximum number of usage sessions indicated by the limitation parameter. Optionally, the method may further comprise storing the number of usage sessions in a counter of the aerosol-generating device, for example an electronic or mechanical counter. Further optionally, the method may comprise comparing the number of usage sessions indicated by the counter of the aerosol-generating device with the maximum number of usage sessions indicated by the limitation parameter.

In yet another example, the method may further comprise determining a number or amount of aerosol-generating articles the aerosol-generating device has been used with to generate aerosol; and one or more of disabling the energy storage, signaling an empty energy storage, triggering re-charging, and requesting re-charging of the energy storage upon determining the number or amount of aerosol-generating articles being equal to or exceeding a maximum number or amount of aerosol-generating articles usable with the aerosol-generating device to generate aerosol, as indicated by the limitation parameter. Optionally, the method may further comprise storing the number or amount of aerosol-generating articles used with the aerosol-generating device in a counter of the aerosol-generating device, for example an electronic or mechanical counter. Further optionally, the method may comprise comparing the number or amount of aerosol-generating articles indicated by the counter of the aerosol-generating device with the maximum number or amount of aerosol-generating articles indicated by the limitation parameter. In yet another example, the method may further comprise measuring an output voltage of the energy storage and comparing the measured output voltage of the energy storage to a minimum output voltage indicated by the limitation parameter. Therein, the output voltage may refer to an open circuit or closed-circuit output voltage.

Optionally, the method may further comprise one or more of disabling the energy storage, signaling an empty energy storage, triggering re-charging, and requesting re-charging of the energy storage in response to determining the measured output voltage of the energy storage being equal to or falling below the minimum output voltage indicated by the limitation parameter.

Alternatively or additionally, the method may comprise controlling a discharge rate of the energy storage based on the limitation parameter. Therein, the discharge rate may, for example, be given as a number of discharging cycles per given period of time, wherein a discharging cycle may refer to depletion of the energy storage from a maximum energy level to a minimum energy level.

In another example, the method may further comprise determining a decrease in energy stored in the energy storage, and one or more of disabling the energy storage, signaling an empty energy storage, triggering re-charging, and requesting re-charging of the energy storage upon determining the decrease in energy stored in the energy storage being equal to or above a fraction of a maximum amount of energy storable in the energy storage indicated by the limitation parameter.

In yet another example, the method may further comprise determining an operation time the aerosol-generating device has been operated to generate aerosol; and one or more of disabling the energy storage, signaling an empty energy storage, triggering re-charging, and requesting re-charging of the energy storage upon determining the operation time of the aerosol-generating device being equal to or exceeding the maximum operation time indicated by the limitation parameter.

In an exemplary implementation of the method, receiving the limitation parameter may include retrieving the limitation parameter from a data storage of the aerosol-generating device.

Alternatively or additionally, the limitation parameter may be received from a computing device and/or a companion device communicatively couplable or coupled to the aerosol-generating device via a communication interface of the aerosol-generating device.

Alternatively or additionally, the method may further comprise receiving one or more user inputs via a user interface of the aerosol-generating device, wherein the limitation parameter may be based on the one or more user inputs received via the user interface of the aerosol-generating device. For example, the user may specify or define the limitation parameter via the user interface. Alternatively or additionally, the device control circuitry may be configured to determine or generate the limitation parameter based on the one or more user inputs.

In an example, the method may further comprise supplying electrical energy to a heating element of the aerosol-generating device or to a heating element of an aerosol-generating article coupled to the aerosol-generating device.

A further aspect of the disclosure relates to a computer program, which when executed by an aerosol-generating device or an aerosol-generating system, instructs the aerosol-generating device or system to perform steps of the method, as described hereinabove and hereinbelow.

A further aspect of the disclosure relates to a computer-readable medium, for example a non-transitory computer-readable medium, storing a computer program, which when executed by an aerosol-generating device or an aerosol-generating system, instructs the aerosol-generating device or system to perform steps of the method, as described hereinabove and hereinbelow

It is emphasized that any feature, step, function, element, technical effect and/or advantage described herein with reference to one aspect of the disclosure equally applies to any other aspect of the disclosure.

In the following illustrative examples and exemplary embodiments of one or more aspects of the present disclosure are summarized. The aerosol-generating device may, for example, refer to an electronic aerosol-generating device or heat-not-burn device usable with various forms or types of aerosol-generating articles. Generally, such electronic devices may be produced in a large scale to individually meet consumption demands of multiple users. Based on a completion of usage, for example a consumption of one or more aerosol-generating articles, the users may dispose the used electronic devices in surrounding environment. In case the used electronic devices are not disposed in a proper manner, such as recycling, the used electronic device may pollute the surrounding environment and may cause unfavourable effects in the surrounding environment. Therefore, it may be favourable to limit the number of aerosol-generating devices that are produced in large scale, to minimize an environmental impact in the surrounding environment. However, in case the number of aerosol-generating devices is limited, it may be difficult to satisfy the demand among multiple users. To address such demand from multiple users, it may be desirable to provide for a technical solution allowing to share a limited number of aerosol-generating devices among multiple users, as can be achieved by controlling the aerosol-generating device based on the limitation parameter, as described herein. Such solution can improve sustainability and leverage as much as possible from each aerosol-generating device without the need to produce multiple devices for multiple users.

Further, in certain cases, the aerosol generating devices may be overused and because of such over usage, there may be excessive charging and/or discharging cycles of the energy storage which may affect service-life of the aerosol-generating device. Therefore, it may be desirable to limit the usage of the aerosol generating device, for example to limit the number of charging and/or discharging cycles to improve service-life of the energy storage, as can be achieved by controlling the aerosol-generating device based on the limitation parameter.

In some other cases, the user may be interested to set a limit to the usage of the aerosol-generating device. For example, the user may set a limit to N inhalation experiences, usage sessions and/or aerosol-generating articles but may end up using the aerosol-generating device more than that. Alternatively or additionally, the user may be interested to optimize his spend to his usage pattern, so again a system preventing the use of the device above a certain threshold set by the user could be beneficial to control his spent. Based on the limitation parameter, the use of the device above a certain threshold value can be advantageously prevented.

The aerosol-generating device of the present disclosure employing usage limitation based on the limitation parameter may, therefore, advantageously be provided at an optimal cost to multiple users, which may commensurate to the actual use of the device. Alternatively or additionally, limiting the usage of the aerosol generating device may advantageously improve service-life of the energy storage of the aerosol-generating device. Alternatively or additionally, an environmental impact of the electronic devices may be reduced by sharing them among different users. Alternatively or additionally, the limitation parameter may enable the user to set a limit to the usage of the aerosol generating device, for example without a risk of forgetting the current or past usage.

In a non-limiting example, the limitation parameter may be associated with a subscription of a user. For instance, a user account may be managed at a computing device, which account may be associated with a subscription, subscription level and/or subscription model. Optionally, the aerosol-generating device may be associated with the account, for example based on an identification number of the aerosol-generating device. Accordingly, the limitation parameter may reflect and/or be indicative of a subscription, subscription level and/or subscription model associated with the user and/or with the aerosol-generating device.

In an example, the aerosol-generating device may be configured to be enabled for a certain subscription limit, such as for a certain amount or number of aerosol-generating articles and/or for a certain time of usage of the aerosol generating device, as indicated by the limitation parameter. Based on the completion of the certain subscription limit, the aerosol generating article may be controlled, such as disabled to prevent further use, or enabled for further use. In certain cases, the device may be controlled, for example enabled or disabled, by a computing device and/or companion device communicably coupled with the aerosol-generating device.

In another example, the aerosol-generating device may be configured to be enabled for a certain consumption limit, such as a certain amount or number of aerosol-generating articles based on the subscription of the aerosol generating device for the certain consumption limit and/or based on the limitation parameter. Based on the completion of the certain consumption limit reflected by the limitation parameter, the aerosol-generating device may be controlled, such as disabled to prevent further use, or enabled for further use, for example as per the renewal of the subscription and/or per receipt of a corresponding limitation parameter.

In another example, the aerosol-generating device may be configured to be enabled for a certain or predefined period as per the subscription indicated by the limitation parameter for the certain consumption period. The certain period may be determined based on a counter, such as a mechanical counter or an electronic counter. Based on the completion of the certain or predefined period, the aerosol generating device may be controlled, such as disabled to prevent further use, or enabled for further use, for example as per the renewal of the subscription and per receipt of a corresponding limitation parameter.

In yet another example, the aerosol generating device may be configured to be enabled for a certain or predefined consumption limit within a certain or predefined consumption period, such as a certain amount or number of aerosol-generating articles utilized within a certain consumption period of time, based on the subscription and/or limitation parameter that may be indicative of the predefined consumption limit within the predefined period of time or consumption period. It is noted that consumption period may refer to an operation time of the aerosol-generating device. Below, there is provided a non-exhaustive list of non-limiting examples. Any one or more of the features of these examples may be combined with any one or more features of another example, embodiment, or aspect described herein.

### Example 1

An aerosol-generating device, comprising:
device control circuitry and an energy storage configured to supply electrical energy to the device control circuitry for generating aerosol from an aerosol-generating article;
wherein the device control circuitry is configured to receive a limitation parameter indicative of a limitation to use the aerosol-generating device to generate aerosol; and
wherein the device control circuitry is configured to control the energy storage based on the limitation parameter, such that operation of the aerosol-generating device by a user to generate aerosol is limited in accordance with the limitation parameter.

### Example 1a

The aerosol-generating device according to example 1, wherein the energy storage is configured to supply electrical energy to one or more aerosol generators for generating aerosol from at least a portion of an aerosol-generating article couplable to the aerosol-generating device.

### Example 1b

The aerosol-generating device according to any one of the preceding examples, wherein the energy storage is configured to supply electrical energy to at least one heating element to heat at least a portion of the aerosol-generating article couplable to the aerosol-generating device.

### Example 1c

The aerosol-generating device according to any one of the preceding examples, wherein the device control circuitry is operatively coupled to the energy storage.

### Example 2

The aerosol-generating device according to any one of the preceding examples, wherein the limitation parameter is indicative of an amount of electrical energy available to the user to generate aerosol.

### Example 3

The aerosol-generating device according to any one of the preceding examples, wherein the device control circuitry is configured to control an amount of electrical energy available to the user to generate aerosol based on the limitation parameter.

### Example 4

The aerosol-generating device according to any one of the preceding examples, wherein the limitation parameter is indicative of one or more predefined values for one or more operational parameters associated with operation of the aerosol-generating device to generate aerosol.

### Example 5

The aerosol-generating device according to any one of the preceding examples, wherein the limitation parameter is indicative of one or more of a predefined output voltage of the energy storage, a predefined charging energy suppliable to the energy storage, a predefined potential energy of the energy storage associated with a change in configuration of internal chemical elements of the energy storage, and a predefined number of charging cycles the energy storage is chargeable; and/or
wherein the device control circuitry is configured to determine, based on the limitation parameter, one or more of a predefined output voltage of the energy storage, a predefined charging energy suppliable to the energy storage, a predefined potential energy of the energy storage associated with a change in configuration of internal chemical elements of the energy storage, and a predefined number of charging cycles the energy storage is chargeable.

### Example 6

The aerosol-generating device according example 5, wherein the predefined output voltage of the energy storage is indicative of an open circuit voltage or a closed-circuit voltage of the energy storage.

### Example 7

The aerosol-generating device according to any one of the preceding examples, wherein the limitation parameter is indicative one or more of a minimum output voltage, a maximum charging energy suppliable to the energy storage, a maximum charging time, a maximum charging current, a maximum charging voltage, and a maximum number of charging cycles the energy storage is chargeable.

### Example 8

The aerosol-generating device according to any one of the preceding examples, wherein the device control circuitry is configured to control, based on the limitation parameter, an amount of electrical energy available to the user by controlling charging of the energy storage in one or more charging cycles of the energy storage.

### Example 9

The aerosol-generating device according to any one of the preceding examples, wherein the device control circuitry is configured to one or more of terminate a charging cycle of the energy storage, signal completion of a charging cycle, signal an empty energy storage the user, trigger re-charging of the energy storage, request re-charging of the energy storage, disable the aerosol-generating device for aerosol generation, and enable the aerosol-generating device for aerosol generation based on the limitation parameter.

### Example 10

The aerosol-generating device according to any one of the preceding examples, wherein the device control circuitry is configured to determine one or more actual values of one or more operational parameters and compare the one or more actual values to one or more predefined values of the one or more operational parameters indicated by the limitation parameter; and
wherein the device control circuitry is configured to one or more of terminate a charging cycle of the energy storage, signal completion of a charging cycle, signal an empty energy storage to the user, trigger re-charging of the energy storage, request re-charging of the energy storage, disable the aerosol-generating device for aerosol generation, and enable the aerosol-generating device for aerosol generation based on the comparison.

### Example 11

The aerosol-generating device according to any one of the preceding examples, wherein the limitation parameter is indicative of a maximum charging energy suppliable to the energy storage for charging the energy storage, and wherein the device control circuitry is configured to control a charging energy suppliable to the energy storage based on the maximum charging energy indicated by the limitation parameter.

### Example 12

The aerosol-generating device according to example 11, wherein the device control circuitry is configured to control the charging energy based on controlling one or more of a charging time, a charging voltage, and a charging current of the energy storage.

### Example 13

The aerosol-generating device according to any one of the preceding examples, wherein the device control circuitry is configured to terminate a charging cycle of the energy storage upon determining a charging energy supplied to the energy storage equal to or exceeding a maximum charging energy indicated by the limitation parameter.

### Example 14

The aerosol-generating device according to any one of the preceding examples, wherein the device control circuitry is configured to terminate a charging cycle of the energy storage upon determining one or more of a charging current, a charging time, and a charging voltage of the energy storage equal to or exceeding one or more of a maximum charging current, a maximum charging time, and a maximum charging voltage indicated by the limitation parameter.

### Example 15

The aerosol-generating device according to any one of the preceding examples, wherein the limitation parameter is indicative of a maximum number of charging cycles the energy storage is chargeable; and
wherein the device control circuitry is configured to control an amount of electrical energy available to the user based on limiting a number of charging cycles of the energy storage in accordance with the limitation parameter.

### Example 16

The aerosol-generating device according to any one of the preceding examples, further comprising a data storage storing a plurality of predefined configurations of the energy storage associated with one or more predefined capacity levels of the energy storage; and
wherein the device control circuitry is configured to select one of the plurality of predefined configurations based on the limitation parameter and to configure the energy storage into the selected configuration.

### Example 17

The aerosol-generating device according to any one of the preceding examples, further comprising an energy storage controller, wherein the device control circuitry is configured to control the energy storage based on configuring the energy storage controller based on the limitation parameter.

### Example 18

The aerosol-generating device according to any one of the preceding examples, wherein the device control circuitry is configured to control, based on the limitation parameter, an amount of electrical energy available to the user based on controlling discharging of the energy storage in one or more charging cycles of the energy storage.

### Example 19

The aerosol-generating device according to any one of the preceding examples, wherein the limitation parameter is indicative of a maximum number of usage sessions the aerosol-generating device is operable by the user to generate aerosol; and
wherein the device control circuitry is configured to one or more of disable the energy storage, signal an empty energy storage, trigger re-charging, and request re-charging of the energy storage upon determining a number of usage sessions the aerosol-generating device has been operated to generate aerosol equal to or exceeding the maximum number of usage sessions indicated by the limitation parameter.

### Example 20

The aerosol-generating device according to any one of the preceding examples, further comprising a counter for counting a number of usage sessions the aerosol-generating device has been used to generate aerosol; and
wherein the device control circuitry is configured to control the energy storage based on comparing the number of usage sessions indicated by the counter with a maximum number of usage sessions indicated by the limitation parameter.

### Example 21

The aerosol-generating device according to any one of the preceding examples, wherein the limitation parameter is indicative of a predefined output voltage of the energy storage; and
wherein the device control circuitry is configured to measure an output voltage of the energy storage and to compare the measured output voltage of the energy storage to the predefined output voltage indicated by the limitation parameter.

### Example 22

The aerosol-generating device according to example 21, wherein the device control circuitry is configured to one or more of disable the energy storage, signal an empty energy storage, trigger re-charging, and request re-charging of the energy storage upon determining the measured output voltage of the energy storage being equal to or falling below the predefined output voltage indicated by the limitation parameter.

### Example 23

The aerosol-generating device according to any one of the preceding examples, wherein the device control circuitry is configured to control a discharge rate of the energy storage based on the limitation parameter.

### Example 24

The aerosol-generating device according to any one of the preceding examples, wherein the limitation parameter is indicative of a fraction of a maximum amount of energy storable in the energy storage; and
wherein the device control circuitry is configured to one or more of disable the energy storage, signal an empty energy storage, trigger re-charging, and request re-charging of the energy storage upon determining a decrease in energy stored in the energy storage equal to or above the fraction of the maximum amount of energy storable indicated by the limitation parameter.

### Example 25

The aerosol-generating device according to any one of the preceding examples, wherein the limitation parameter is indicative of a maximum operation time the aerosol-generating device is operable by the user to generate aerosol; and
wherein the device control circuitry is configured to one or more of disable the energy storage, signal an empty energy storage, trigger re-charging, and request re-charging of the energy storage upon determining an operation time of the aerosol-generating device equal to or exceeding the maximum operation time indicated by the limitation parameter.

### Example 26a

The aerosol-generating device according to any one of the preceding examples, wherein the limitation parameter is indicative of a maximum number of aerosol-generating articles the aerosol-generating device is usable by the user; and
wherein the device control circuitry is configured to one or more of disable the energy storage, signal an empty energy storage, trigger re-charging, and request re-charging of the energy storage upon determining a number of aerosol-generating articles used with the aerosol-being equal to or exceeding the maximum number of aerosol-generating articles indicated by the limitation parameter.

### Example 26b

The aerosol-generating device according to any one of the preceding examples, wherein the limitation parameter is indicative of a time period the aerosol-generating device is operable to generate aerosol, optionally wherein the limitation parameter is indicative of one or more of a start date, from which the device is operable to generated aerosol, and an end date, until which the aerosol-generating device is operable to generate aerosol.

### Example 27

The aerosol-generating device according to any one of the preceding examples, wherein the device control circuitry is configured to retrieve the limitation parameter from a data storage of the aerosol-generating device.

### Example 28

The aerosol-generating device according to any one of the preceding examples, further comprising a communication interface for communicatively coupling the aerosol-generating device to a computing device; and
wherein the aerosol-generating device is configured to receive the limitation parameter from the computing device via the communication interface.

### Example 29

The aerosol-generating device according to example 28, wherein the computing device includes a server or a mobile device.

### Example 30

The aerosol-generating device according to any one of the preceding examples, further comprising a user interface for receiving one or more user inputs; and
wherein the limitation parameter is based on one or more user inputs received via the user interface of the aerosol-generating device.

### Example 31

The aerosol-generating device according to any one of the preceding examples, wherein the aerosol-generating device is couplable to a companion device for supplying electrical energy to the energy storage; and
wherein the aerosol-generating device is configured to receive the limitation parameter from the companion device upon coupling the aerosol-generating device to the companion device.

### Example 32

The aerosol-generating device according to any one of the preceding examples, further comprising at least a part of a heating element coupled to the energy storage and configured to heat at least a portion of an aerosol-generating article.

### Example 33a

The aerosol-generating device according to any one of the preceding examples, wherein the aerosol-generating device is couplable to an aerosol-generating article including at least a part of a heating element; and
wherein the energy storage is configured to supply electrical energy to the at least part of the heating element of the aerosol-generating article to generate aerosol.

### Example 33b

The aerosol-generating device according to any one of the preceding examples, wherein the aerosol comprises nicotine.

### Example 34

An aerosol-generating system, comprising:
an aerosol-generating device according to any one of the preceding examples, and
an aerosol-generating article couplable to the aerosol-generating device to generate aerosol from at least a portion of the aerosol-generating article, optionally based on heating at least a portion of an aerosol-generating article.

### Example 34a

The aerosol-generating system according to example 34, wherein the aerosol-generating article comprises an aerosol-generating substrate comprising nicotine.

### Example 35

Use of an aerosol-generating device according to any one of examples 1 to 33b or an aerosol-generating system according to any one of examples 34 and 34a to generate aerosol.

### Example 36

A method of operating an aerosol-generating device including an energy storage configured to supply electrical energy to device control circuitry for generating aerosol from an aerosol-generating article, the method comprising:
receiving, with the device control circuitry, a limitation parameter indicative of a limitation to use the aerosol-generating device to generate aerosol; and
configuring, with the device control circuitry, the energy storage based on the limitation parameter, thereby limiting operation of the aerosol-generating device by a user to generate aerosol in accordance with the limitation parameter.

### Example 36a

The method according to example 36, wherein the energy storage is configured to supply electrical energy to one or more aerosol generators for generating aerosol from at least a portion of an aerosol-generating article couplable to the aerosol-generating device.

### Example 36b

The method according to any one of examples 36 to 36a, wherein the energy storage is configured to supply electrical energy to at least one heating element to heat at least a portion of the aerosol-generating article couplable to the aerosol-generating device.

### Example 36c

The method according to any one of examples 36 to 36b, wherein the device control circuitry is operatively coupled to the energy storage.

### Example 37

The method according to any one of examples 36 to 36c, further comprising controlling an amount of electrical energy available to the user to generate aerosol based on the limitation parameter.

### Example 38

The method according to any one of examples 36 to 37, further comprising determining, based on the limitation parameter, one or more of a predefined output voltage of the energy storage, a predefined charging energy suppliable to the energy storage, a predefined potential energy of the energy storage associated with a change in configuration of internal chemical elements of the energy storage, and a predefined number of charging cycles the energy storage is chargeable.

### Example 39

The method according to any one of examples 36 to 38, further comprising controlling, based on the limitation parameter, an amount of electrical energy available to the user by controlling one or more of charging and discharging of the energy storage in one or more charging cycles.

### Example 40

The method according to any one of examples 36 to 39, further comprising one or more of terminating a charging cycle of the energy storage, signaling completion of a charging cycle, signaling an empty energy storage to the user, triggering re-charging of the energy storage, requesting re-charging of the energy storage, disabling the aerosol-generating device for aerosol generation, and enabling the aerosol-generating device for aerosol generation based on the limitation parameter.

### Example 41

The aerosol-generating device according to any one of examples 36 to 40, further comprising determining one or more actual values of one or more operational parameters;
comparing the one or more actual values to one or more predefined values of the one or more operational parameters indicated by the limitation parameter; and
one or more of terminating a charging cycle of the energy storage, signaling completion of a charging cycle, signaling an empty energy storage to the user, triggering re-charging of the energy storage, requesting re-charging of the energy storage, disabling the aerosol-generating device for aerosol generation, and enabling the aerosol-generating device for aerosol generation based on the comparing.

### Example 42

The method according to any one of examples 36 to 41, further comprising controlling a charging energy supplied to the energy storage based on controlling one or more of a charging time, a charging voltage, and a charging current of the energy storage.

### Example 43

The method according to any one of examples 36 to 42, further comprising determining a charging energy the energy storage has been supplied with; and terminating a charging cycle of the energy storage in response to determining the charging energy being equal to or exceeding a maximum charging energy indicated by the limitation parameter.

### Example 44

The method according to any one of examples 36 to 43, further comprising terminating a charging cycle of the energy storage upon determining one or more of a charging current, a charging time and a charging voltage of the energy storage has been charged with being equal to or exceeding one or more of a maximum charging current, a maximum charging time and a maximum charging voltage indicated by the limitation parameter.

### Example 45

The method according to any one of examples 36 to 44, further comprising limiting a number of charging cycles of the energy storage in accordance with the limitation parameter, thereby controlling an amount of electrical energy available to the user.

### Example 46

The method according to any one of examples 36 to 45, wherein the aerosol-generating device further comprises a data storage storing a plurality of predefined configurations of the energy storage associated with one or more predefined capacity levels of the energy storage, and wherein the method further comprises selecting one of the plurality of predefined configurations based on the limitation parameter and configuring the energy storage into the selected configuration.

### Example 47

The method according to any one of examples 36 to 46, further comprising configuring, by the device control circuitry, an energy storage controller based on the limitation parameter.

### Example 48

The method according to any one of examples 36 to 47, further comprising determining a number of usage sessions the aerosol-generating device has been operated to generate aerosol; and one or more of disabling the energy storage, signaling an empty energy storage, triggering re-charging, and requesting re-charging of the energy storage upon determining the number of usage sessions being equal to or exceeding a maximum number of usage sessions indicated by the limitation parameter.

### Example 49

The method according to example 47, further comprising comparing the number of usage sessions indicated by a counter of the aerosol-generating device with the maximum number of usage sessions indicated by the limitation parameter.

### Example 50

The method according to any one of examples 36 to 49, further comprising measuring an output voltage of the energy storage and comparing the measured output voltage of the energy storage to a minimum output voltage indicated by the limitation parameter.

### Example 51

The method according to example 50, further comprising one or more of disabling the energy storage, signaling an empty energy storage, triggering re-charging, and requesting re-charging of the energy storage in response to determining the measured output voltage of the energy storage being equal to or falling below the minimum output voltage indicated by the limitation parameter.

### Example 52

The method according to any one of examples 36 to 51, further comprising controlling a discharge rate of the energy storage based on the limitation parameter.

### Example 53

The method according to any one of examples 36 to 52, further comprising determining a decrease in energy stored in the energy storage; and one or more of disabling the energy storage, signaling an empty energy storage, triggering re-charging, and requesting re-charging of the energy storage upon determining the decrease in energy stored in the energy storage being equal to or above a fraction of a maximum amount of energy storable in the energy storage indicated by the limitation parameter.

### Example 54

The method according to any one of examples 36 to 53, further comprising determining an operation time the aerosol-generating device has been operated to generate aerosol; and one or more of disabling the energy storage, signaling an empty energy storage, triggering re-charging, and requesting re-charging of the energy storage upon determining the operation time of the aerosol-generating device being equal to or exceeding the maximum operation time indicated by the limitation parameter.

### Example 55

The method according to any one of examples 36 to 54, further comprising determining a number of aerosol-generating articles used with the aerosol; and one or more of disabling the energy storage, signaling an empty energy storage, triggering re-charging, and requesting re-charging of the energy storage upon determining the number of aerosol-generating articles used with the aerosol-device being equal to or exceeding the maximum number of aerosol-generating articles indicated by the limitation parameter.

### Example 56

The method according to any one of examples 36 to 55, wherein receiving the limitation parameter includes retrieving the limitation parameter from a data storage of the aerosol-generating device.

### Example 57

The method according to any one of examples 36 to 56, wherein the limitation parameter is received from a computing device and/or a companion device communicatively couplable to the aerosol-generating device via a communication interface of the aerosol-generating device.

### Example 58

The method according to any one of examples 36 to 57, further comprising receiving one or more user inputs via a user interface of the aerosol-generating device, wherein the limitation parameter is based on the one or more user inputs received via the user interface of the aerosol-generating device.

### Example 59

The method according to any one of examples 36 to 58, further comprising supplying electrical energy to a heating element of the aerosol-generating device or to a heating element of an aerosol-generating article coupled to the aerosol-generating device.

### Example 59a

The method according to any one of examples 36 to 59, wherein the aerosol contains nicotine.

### Example 59b

The method according to any one of examples 36 to 59a, wherein the aerosol-generating article comprises an aerosol-generating substrate comprising nicotine.

### Example 60

A computer program, which when executed by an aerosol-generating device or an aerosol-generating system, instructs the aerosol-generating device or system to perform steps of the method according to any one of examples 36 to 59.

### Example 61

Non-transitory computer-readable medium storing a computer program according to example 60.

Examples will now be further described with reference to the Figures in which:

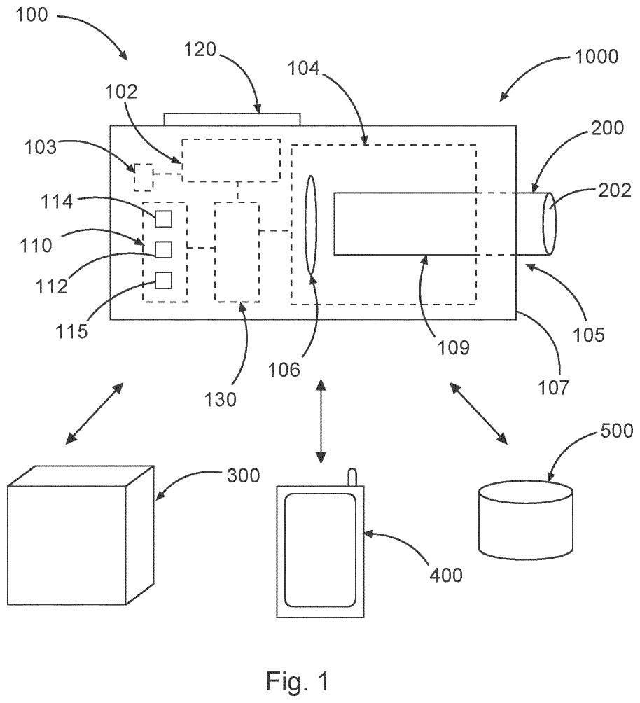

FIG. 1 shows an aerosol-generating device and aerosol-generating system;

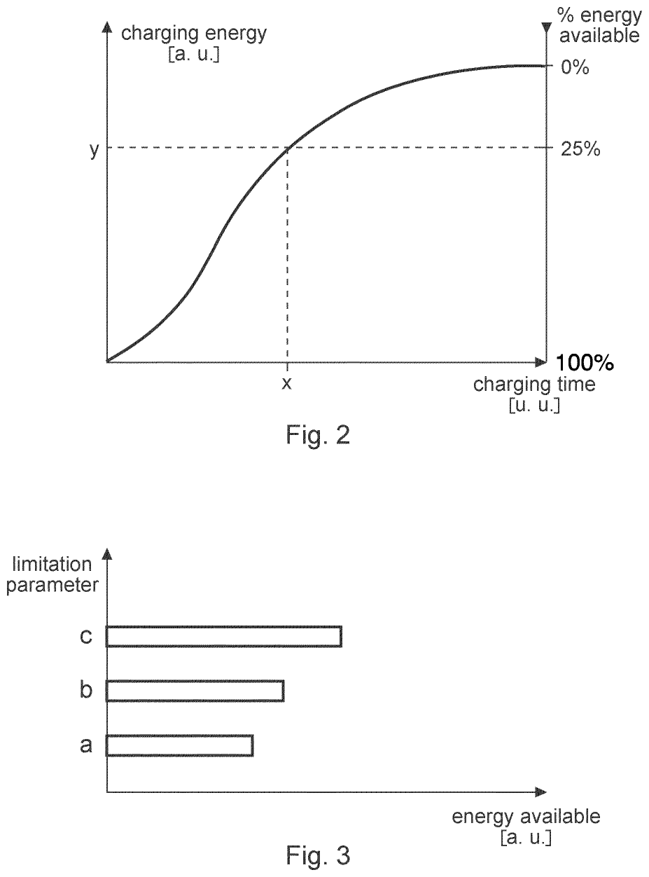

FIG. 2 shows an exemplary charging profile of an energy storage of an aerosol-generating device;

FIGS. 3 to 5 illustrate exemplary applications of one or more limitation parameters in an aerosol-generating device; and

FIG. 6 illustrates a method of operating an aerosol-generating device.

The Figures are schematic only and not true to scale. In principle, identical or like parts, elements and/or steps are provided with identical or like reference numerals in the figures.

FIG. 1 shows an exemplary aerosol-generating device 100. The aerosol-generating device 100 of FIG. 1 is exemplary shown as part of an aerosol-generating system 1000, which includes optional components, such as an aerosol-generating article 200, a companion device 300, a mobile device 400, and a computing device 500. It is noted that the aerosol-generating device 100 may be operated as standalone device 100 without any of the optional components 200, 300, 400, 500 of the system 1000.

The aerosol-generating device 100 includes one or more energy storages 102 for storing electrical energy and/or for providing electrical energy to generate aerosol. The one or more energy storages may be one or more batteries (e.g. a lithium-ion battery). When the energy storage(s) 102 is/are a battery/batteries the cathode material may comprise lithium-cobalt-oxide (LCO), lithium-manganese-oxide (LMO), lithium-nickel-manganese-cobalt-oxide (NMC), lithium-iron-phosphate (LFP), and/or lithium-nickel-cobalt-aluminium-oxide (NCA). The anode material may comprise carbon (e.g. graphite), silicon and/or lithium-titanate-oxide (LTO).

The exemplary aerosol-generating device 100 shown in FIG. 1 includes at least a part of a heating circuit 104 with at least one heating element 106 for heating at least a part of an aerosol-generating article 200 couplable to the aerosol-generating device 100. It should be noted that the heating circuit 104 and heating element 106 are optional only. Alternatively or additionally, at least a part of or the entire heating circuit 104 and/or heating element 106 may be integrated or arranged in the aerosol-generating article 200.

Also, it should be noted that the heating element 106 is merely for illustrative purposes shown in FIG. 1 as inductive coil configured to inductively heat at least a part of the aerosol-generating article 200, for example a susceptor material arranged in an aerosol-generating substrate 202 of the aerosol-generating article 200. Alternatively or additionally, the at least one heating element 106 may be configured for one or more of resistive heating and microwave heating.

Further, it should be noted that the aerosol-generating article 200 is only exemplary shown in FIG. 1 as having a stick-like or tubular shape and as being at least partially insertable through an opening 105 of a housing 107 of the aerosol-generating device 100, for example into a heating chamber 109 of the aerosol-generating device 100. In other exemplary designs, the aerosol-generating article 200 may be shaped as container or cartridge that may be fixedly integrated in the aerosol-generating device 100 or that may be couplable to the device 100.

The aerosol-generating device 100 further comprises device control circuitry 110 or control circuitry 110 operatively coupled to the energy storage 102. The device control circuitry 110 may optionally include one or more processors 112 for data processing. The control circuitry 110 may optionally comprise a microcontroller comprising a processor, memory and input/output means.

Further optionally, the aerosol-generating device 100 and/or the device control circuitry 110 includes a data storage 114 for storing data, such as for example the limitation parameter or other data. Alternatively or additionally, software instructions may be stored in the data storage 114, which when executed by the device control circuitry 112 instruct the aerosol-generating device 100 to perform one or more functions of the device 100, as described hereinabove and hereinbelow.

The aerosol-generating device 100 optionally includes a user interface 120 for receiving one or more user inputs from a user, for example to operate the aerosol-generating device 100 to generate aerosol. The user interface 120 is exemplary shown as button in FIG. 1. Any other type of user interface 120, such as an acoustic interface, a haptic interface, a touch interface, a display, or the like can be optionally included in the aerosol-generating device 100 in the alternative or in addition.

Further optionally, the aerosol-generating device 100 includes a communication interface or circuitry 130 for communicatively coupling the aerosol-generating device 100 to one or more optional components of the aerosol-generating system 1000, in particular to one or more of the companion device 300, the mobile device 400, and the computing device 500.

As mentioned hereinabove, one or more communication interface types or communication protocols may be implemented in the aerosol-generating device 100 and its communication interface or circuitry 130. In particular, the communication interface or circuitry 130 may be configured for one or both wired and wireless communication with one or more of the computing device 500, the mobile device 400 and the companion device 300. For example, the communication interface 130 may be based on one or more of a BUS communication, a cable communication, a Bluetooth communication, a Wireless Local Area Network communication, an infrared communication, a nearfield communication, an internet communication or any other suitable type of communication or communication protocol.

As mentioned hereinabove, the aerosol-generating device 100 may optionally be coupled to, for example at least partly inserted into, the companion device 300 for charging the energy storage 102 and/or for storing the aerosol-generating device 100. Charging may, for example, be based on inductive charging or via electrical connections.

The aerosol-generating device 100 and/or the device control circuitry 110 is configured to supply electrical energy to the at least one heating element 106 to heat at least a portion of the aerosol-generating article 200. Further, the device control circuitry 110 is configured to receive a limitation parameter indicative of a limitation to use the aerosol-generating device 100 to generate aerosol, wherein the device control circuitry 110 is configured to control the energy storage 102 based on the limitation parameter, such that operation of the aerosol-generating device 100 by a user to generate aerosol is limited in accordance with the limitation parameter.

The limitation parameter may be received by the device control circuitry 110 based on retrieving the limitation parameter from the data storage 114. Alternatively or additionally, the limitation parameter may be based on one or more user inputs received at the user interface 120. Alternatively or additionally, the limitation parameter may be received from any one or more of the companion device 300, the mobile device 400 and the computing device 500.

In the following, various exemplary designs and configurations of the aerosol-generating device 100 are described and summarized. In an example, the limitation parameter may be indicative of an amount of electrical energy available to the user to generate aerosol, which is also referred to herein as available energy, and the device control circuitry 110 may be configured to control the amount of energy available based on controlling one or both of charging and discharging of the energy storage 102.

Alternatively or additionally, the limitation parameter may be indicative of one or more predefined values for one or more operational parameters associated with operation of the aerosol-generating device 100 to generate aerosol. For example, the device control circuitry 110 may be configured to monitor the one or more operational parameters during use or operation of the aerosol-generating device 100. Alternatively or additionally, the device control circuitry 110 may be configured to determine whether one or more predefined or threshold values for the one or more operational parameters indicated by the limitation parameter are reached. This may include a comparison of one or more values of one or more monitored operational parameters with the one or more predefined or threshold values for the one or more operational parameters indicated by the limitation parameter.

By way of example, the limitation parameter may be indicative of one or more of a predefined output voltage of the energy storage, a predefined charging energy suppliable to the energy storage to re-charge the energy storage, a predefined potential energy of the energy storage associated with a change in configuration of internal chemical elements of the energy storage, and a predefined number of charging cycles the energy storage is chargeable. Other exemplary predefined values for operational parameters may be a predefined number of usage sessions the aerosol-generating device can be used to generate aerosol, a predefined operation time the aerosol-generating device can be used to generate aerosol, a predefined number of aerosol-generating articles that can be used or consumed with the aerosol-generating device, a predefined number of puffs or inhalations the user can take, a predefined amount of aerosol-generating substrate or article usable with the aerosol-generating device, and an amount of energy drawable from the energy storage for aerosol generation. Any one or more of the aforementioned as well as other operational parameters may be considered or reflected by the limitation parameter and used to infer the usage limitation to the aerosol-generating device 100.

For instance, the device control circuitry 110 may be configured to determine one or more actual values of one or more operational parameters and compare the one or more actual values to one or more predefined values of the one or more operational parameters indicated by the limitation parameter, wherein the device control circuitry 110 may be configured to one or more of terminate a charging cycle of the energy storage, signal completion of a charging cycle, signal an empty energy storage to the user, trigger re-charging of the energy storage 102, request re-charging of the energy storage 102, disable the aerosol-generating device 100 for aerosol generation, and enable the aerosol-generating device 100 for aerosol generation based on the comparison.

In yet another example, the limitation parameter may be indicative one or more threshold values for one or more operational parameters related to charging or discharging of the energy storage 102, such as a minimum output voltage, a maximum charging energy suppliable to the energy storage, a maximum charging time, a maximum charging current, a maximum charging voltage, and a maximum number of charging cycles the energy storage is chargeable. Therein, the device control circuitry 110 may be configured to control, based on the limitation parameter, an amount of electrical energy available to the user by controlling charging of the energy storage 102 in one or more charging cycles of the energy storage 102.

For example, the device control circuitry 110 may be configured to control a charging energy suppliable to the energy storage based on the maximum charging energy indicated by the limitation parameter. This may include controlling one or more of a charging time, a charging voltage, and a charging current of the energy storage 102. For instance, the device control circuitry 110 may be configured to terminate a charging cycle of the energy storage 102 upon determining a charging energy supplied to the energy storage equal to or exceeding a maximum charging energy indicated by the limitation parameter. This may include determining one or more of a charging current, a charging time, and a charging voltage of the energy storage equal to or exceeding one or more of a maximum charging current, a maximum charging time, and a maximum charging voltage indicated by the limitation parameter.

Alternatively or additionally, the limitation parameter may be indicative of a maximum number of charging cycles the energy storage 102 is chargeable, and wherein the device control circuitry 110 may be configured to control an amount of electrical energy available to the user based on limiting a number of charging cycles of the energy storage 102 in accordance with the limitation parameter.

In yet another exemplary configuration, the aerosol-generating device 100 includes an energy storage controller 103, which may be configured by the device control circuitry 110 in accordance with or based on the limitation parameter. For example, a plurality of predefined configurations of the energy storage 102 associated with one or more predefined capacity levels of the energy storage 102 may be stored in the data storage 114, and the device control circuitry may be configured to select one of the plurality of predefined configurations based on the limitation parameter and to configure the energy storage 102 and/or energy storage controller 103 into the selected configuration.

Alternatively or additionally, the limitation parameter may be consumption-based or usage-based. For instance, the limitation parameter may be indicative of a maximum number of usage sessions the aerosol-generating device is operable by the user to generate aerosol, a maximum operation time, a maximum number or amount of aerosol-generating article 200 usable with the device, and a maximum number of inhalations or puffs the user can take.

For this purpose, the aerosol-generating device 100 may optionally include a counter 115, for example a mechanical or electronic counter 115, to determine one or more of an actual number of usage sessions the device 100 has been used, an actual operation time the device 100 has been used, an actual number or amount of aerosol-generating articles 200 used with the device 100, and an actual number of inhalations or puffs the user has taken. Any one or more of these operational parameters may be determined by the device control circuitry 110 and compared to the corresponding threshold value indicated by the limitation parameter. Upon reaching or exceeding one or more of the threshold values, the device control circuitry 110 may be configured to one or more of disable the energy storage 102, signal an empty energy storage 102, trigger re-charging, and request re-charging of the energy storage 102.

In yet another example, the limitation parameter may be indicative of a predefined output voltage of the energy storage 102, and the device control circuitry 110 may be configured to measure an output voltage of the energy storage 102 and to compare the measured output voltage of the energy storage to the predefined output voltage indicated by the limitation parameter. Optionally, the device control circuitry 110 may be configured to one or more of disable the energy storage 102, signal an empty energy storage 102, trigger re-charging, and request re-charging of the energy storage 102 upon determining the measured output voltage of the energy storage 102 being equal to or falling below the predefined output voltage indicated by the limitation parameter.

Alternatively or additionally, the limitation parameter may be indicative of a fraction of a maximum or nominal amount of energy storable in the energy storage 102, and the device control circuitry 110 may be configured to one or more of disable the energy storage, signal an empty energy storage 102, trigger re-charging, and request re-charging of the energy storage upon determining a decrease in energy stored in the energy storage 102 equal to or above the fraction of the maximum amount of energy storable indicated by the limitation parameter.

With continued reference to FIG. 1 and subsequent FIGS. 2 to 5, exemplary and illustrative use cases and embodiments of the aerosol-generating device 100 according to the disclosure are summarized, which can be implemented alone or in combination with any of the functions of the aerosol-generating device 100 described hereinabove. The aerosol-generating device 100 includes an energy storage 102 and a device control circuitry 110. The device control circuitry 110 may be configured to control the energy available to the user to a certain or predefined value based on the limitation parameter.

The limitation parameter may optionally be based on a subscription, subscription model or subscription level of the user. For example based on an active subscription, the available energy of the energy storage 102 to operate the aerosol generating device 100 may be controlled to a higher energy value, for example to be used for a number of N usage sessions by the user. Based on an end of the active subscription and/or based on the limitation parameter, the energy of the energy storage 102 can be reduced to a lower energy value, for example to provide a number of M usage sessions, where M may be smaller than N. Based on further activation of the subscription and corresponding receipt of the limitation parameter at the aerosol-generating device 100, the energy of the energy storage 102 can be controlled again to a higher energy value. In an example, based on the subscription, the available energy of the energy storage 102 may be controlled by a server 500 or computing device 500, for example through a secure channel.

Such example may rely on the control of the energy available to the user by controlling the charging process of the energy storage 102 and/or the discharging process. As used herein, available energy may mean the energy that is available to the user to operate the device to generate aerosol, for example to operate the device 100 normally before a new battery charging process or cycle may be forced by the device 100 or device control circuitry 110 based on the limitation parameter.

The limitation of the charging process may be achieved by limiting for instance the charging time, the charging current and/or the charging voltage of the energy storage 102, and optionally by signalling to the user that the device 100 is ready for use even though theoretically the energy storage 102 could still be further charged. In another example the same effect could be achieved by keeping fixed the charging time and reducing the charging current and/or charging voltage. The reduction of the charged energy may limit the available battery energy and thus may limit the use of the device 100 to a lower number of usage sessions before another charge may be requested or forced.

For example, the computing device 500, the mobile device 400 and/or the companion device 300 may include or communicate with a subscription server transmitting to the aerosol-generating device 100 the limitation parameter, optionally in encrypted form, which limitation parameter may for instance define one or more of a maximum charging time, a maximum charging current, a maximum charging voltage, and a maximum charging energy. For example, these parameters or values may be defined for a constant current phase of a Constant Current-Constant Voltage charging sequence or cycle. Optionally, the device control circuitry 110 may configure the energy storage controller 103 based on the limitation parameter to control the charging process or one or more charging cycles.

FIG. 2 shows an exemplary charging profile of an energy storage 102 of the aerosol-generating device 100. Such or similar charging profile may be stored at one or more of the aerosol-generating device 100, the companion device 300, the mobile device 400 and the computing device 500. Therein, the x-axis shows the charging time in arbitrary units, the left y-axis shows the charging energy in arbitrary units and the right y-axis shows the fraction or percentage of energy available to generate aerosol, relative to a nominal energy storable in or a nominal capacity of the energy storage 102.

By way of example, the energy storage 102 may be usable for a nominal maximum number of usage sessions, such as 20 usage sessions, using the entire energy nominally storable in the energy storage 102. Based on the limitation parameter, only a maximum number of five usage sessions may be allowed, which may translate to a fraction, percentage or level of 25% available energy, as may be determined by the device control circuitry 110, for example based on processing data related to the charging profile and/or based on processing the limitation parameter. Alternatively or additionally, the charging profile can be stored at the companion device 300, the mobile device 400 and/or the computing device 500 and corresponding values may be determined there and transmitted in the form of the limitation parameter or a corresponding control signal to the aerosol-generating device 100.

The device control circuitry 110 may then load a particular maximum charging time indicated by the limitation parameter, such as X minutes, as indicated in FIG. 2. Accordingly, the maximum charging time defined may allow for charging the energy storage 102 with a maximum charging energy of Y mWh (see FIG. 2), which may be stored in one or more charging cycles in the energy storage 102 and used to generate aerosol in five usage sessions. Similarly, the aerosol-generating device 100 can be configured based on the limitation parameter for a 50% use of the energy storage's 102 energy, for example corresponding to ten usage sessions, a 75%, corresponding to 15 usage sessions, or any other percentage or fraction of the energy storage's nominal storage capacity. Alternatively or additionally, the charging current and/or charging voltage may be varied, optionally while keeping the charging time constant.

FIGS. 3 to 5 illustrate exemplary applications of one or more limitation parameters in an aerosol-generating device 100. In particular, FIG. 3 shows several limitation parameters a, b, c, in relation to the energy available to generate aerosol in arbitrary units. Therein, FIG. 3 illustrates a correlation between the available energy and a corresponding limitation parameter a, b, and c, which may optionally be associated with different levels of subscription. In a first case, the aerosol generating device 100 may be provided with a predefined energy suppliable to the energy storage 102 and/or available to the user, such as an energy of 500 mAh, due to or inferred by limitation parameter a, which may correspond to the subscription of a first level. In an example, the aerosol generating device 100 may control the energy storage 102 to limit the charged or discharged energy to 500 mAh as per the selected limitation parameter or level of subscription. Based on the utilization of the energy defined by limitation parameter a, for example 500 mAh, the aerosol generating device 100 may turn off. To further switch-on the aerosol generating device, the user may renew the subscription services and/or update the limitation parameter of the aerosol generating device 100, for example with limitation parameters b or c, which may be associated with a higher energy suppliable to the energy storage 102 and/or usable by the user to generate aerosol. In another example, the limitation parameter a could enable the continuous utilization of the associated energy, meaning that after each recharge, the predefined amount corresponding to limitation parameter a, for example 500 mAh, may be available for use. The user could then decide to keep on recharging with a certain frequency or to update to limitation parameters b or c associated with a higher energy level which would then reduce the frequency of recharge for the same overall consumption.

In a further example, the aerosol generating device 100 may be provided with a second amount of energy suppliable to the energy storage 102 and/or usable to generate aerosol, such as for example 1000 mAh energy corresponding to a second level of subscription. In other words, the available energy of the energy storage 102 of the aerosol-generating device 100 may be set or enhanced to the 1000 mAh energy based on limitation parameter b. In an example, the aerosol generating device 100 may control the energy storage 102, for instance transmit a command to the energy storage 102, associated with the aerosol generating device to control, such as increase, the available energy to the predefined value indicated by limitation parameter b, for example to 1000 mAh in the second level of subscription. The increased available energy may allow the user to consume a greater number of aerosol-generating articles 200 or use the aerosol generating device 100 for a longer period of time before re-charging. Similarly to the example with limitation parameter a, the available energy defined by limitation parameter b could be achieved by controlling the charging and/or discharging process. Based on a discharge of the energy available indicated by the limitation parameter b, the aerosol generating device 100 may turn off or be disabled or even be kept active so to enable a higher amount of available energy after each charging cycle, as compared to the previous example with limitation parameter a.

In analogy to the previous two examples with limitation parameters a and b, the aerosol generating device may be provided with a limitation parameter c associated with an even higher energy available, such as 1500 mAh of available energy. Limitation parameter c may be loaded by subscribing to a third level of subscription and/or receiving the corresponding limitation parameter c or control signal at the aerosol-generating device 100.

In certain cases, the aerosol generating device 100 may remotely communicate with a computing device 500, such as a cloud server, to receive information associated with the limitation parameter, and for example associated with an available energy, such as information associated with a voltage, current, and/or power of the energy storage 102. In such cases, the computing device 500 may control the aerosol generating device 100, for example communicate commands, based on the information associated with the limitation parameter and/or subscribed available energy stored at the computing device 500. The available energy may relate to one or more of an open voltage of the energy storage, a charging current of the energy storage, a charging time of the storage, or a change in potential energy of the energy storage 102 based on a change in configuration of internal chemical elements of the energy storage 102. In an example, various ranges of the available energy storage capacities or energies may be pre-set or predefined in the aerosol-generating device 100. Based on the discharge of available energy, the aerosol generating device 100 may be controlled, such as disabled to prevent further use, or enabled based on the renewed or updated limitation parameter. Alternatively or additionally to the computing device 500, the mobile device 400 or companion device 300 may be used to transmit the limitation parameter to the aerosol-generating device 100.

As also described with reference to FIG. 1, the aerosol-generating device 100 may include an energy storage controller 103. The device control circuitry 110 may be configured to communicate with the computing device 500, mobile device 400 and/or companion device 300 to transmit or receive information associated with the limitation parameter and/or the energy storage 102. A plurality of configurations of the aerosol generating device 100 or energy storage 102 may be stored, for example at the data storage 114, such as a first, second and third configuration.

In the first configuration, the aerosol generating device 100 may be set with an initial available energy, for example 500 mAh to use M number of aerosol-generating articles or usage sessions. Once the limitation parameter and associated available energy is uploaded to the aerosol-generating device 100, operation up to utilization of the available energy may be allowed and prohibited when the available energy has been used. In the latter case, to further utilize the aerosol generating device 100, an updated limitation parameter may be transmitted to the aerosol-generating device 100. Alternatively or additionally, the aerosol-generating device 100 may be further operated with the same available energy until the limitation parameter may be updated and/or replaced, for example configured into an upgraded configuration in correspondence with an upgraded subscription level or configured into a downgraded configuration in correspondence with a downgraded subscription level.

In the upgraded configuration, based on the higher energy available to generate aerosol, for example 1000 mAh, the aerosol generating device 100 may be used for an increased number N of experiences, aerosol-generating articles and/or usage sessions, for example for N usage sessions, where N may be larger than M, as compared to a default configuration associated with a limitation parameter indicating a number of M experiences, aerosol-generating articles and/or usage sessions. Once the corresponding limitation parameter and available energy indicated thereby is uploaded or received at the aerosol-generating device 100, such configuration may be configured in the same or similar way as described above.

In the limited or downgraded configuration, the aerosol generating device may be operated for a limited number of O experiences, usage sessions and/or aerosol-generating articles, where O may be smaller than M, as compared to the default number M of experiences, usage sessions and/or aerosol-generating articles. Based on user interest and/or limitation parameter, the aerosol generating device 100 may control the energy storage 102 to charge and/or discharge at the limited energy. Once the corresponding limitation parameter and available energy indicated thereby is uploaded or received at the aerosol-generating device 100, such configuration may be configured in the same or similar way as described above.

In another example, the available energy may be controlled by limiting discharging or a discharge process based on the limitation parameter, and optionally based on a subscription level associated therewith. The limitation of the discharging process may be achieved based on a consumption-based or usage-based limitation parameter. This can be implemented, for example, by defining with the limitation parameter the number of aerosol-generating articles, the number of usage sessions, and/or the number of inhalations possible to the user after the energy storage 102 has been charged and by signalling to the user that the device 100 needs further charging even though theoretically the energy storage 102 could still be further discharged. In other words, a re-charge may be forced based on the limitation parameter.

For instance, based on the limitation parameter, optionally based on a subscription level and the device 100 in possession to the user, the maximum number of aerosol-generating articles, the maximum number of usage sessions, and/or the maximum number of inhalations allowed before forcing a recharge may be determined. This number may be passed through an encrypted and secure channel, for example from the computing device 500, mobile device 400 or companion device 300 to the device control circuitry 110 of the aerosol-generating device 100. The aerosol-generating device 100 and/or the device control circuitry 110 may include a counter 115 that may be set to the number defined by the limitation parameter and decreased each time the corresponding operational parameter, respectively, the number of aerosol-generating articles, the number of usage sessions, and/or the number of inhalations is increased. Upon reaching the maximum number indicated by the limitation parameter, the device control circuitry 110 may prevent further start of a heating sequence and may force on the interface 120 a signal to inform the user about the need to recharge.

Alternatively or additionally, an output voltage, such as an open voltage of the energy storage 102 may be measured. As soon as the measured output voltage has decreased to a predetermined value indicated by the limitation parameter, the device control circuitry 110 may again force a recharge and/or prompt the user to recharge.

For instance, the aerosol-generating device 100 may be controlled by controlling the discharge rate of the usable energy of the energy storage 102 based on the limitation parameter, and optionally based on a level of subscription associated therewith. For example, the aerosol generating device 100 may control the energy storage 102 to allow a discharge of a particular percentage, such as 20%, of the nominal energy or storage capacity of the energy storage 102 based on a particular limitation parameter and/or level of subscription. Based on the discharge of the particular percentage, such as 20%, of the nominal energy or storage capacity of the energy storage 102, the aerosol generating device 100 may prompt the user to update the limitation parameter to use the remaining, for example 80%, of the nominal energy of the energy storage 102. Based on a complete discharge of the energy storage 102, the aerosol generating device may be controlled, such as disabled to prevent further use, or enabled for recharge, based on the updated limitation parameter and/or renewed subscription for further use.

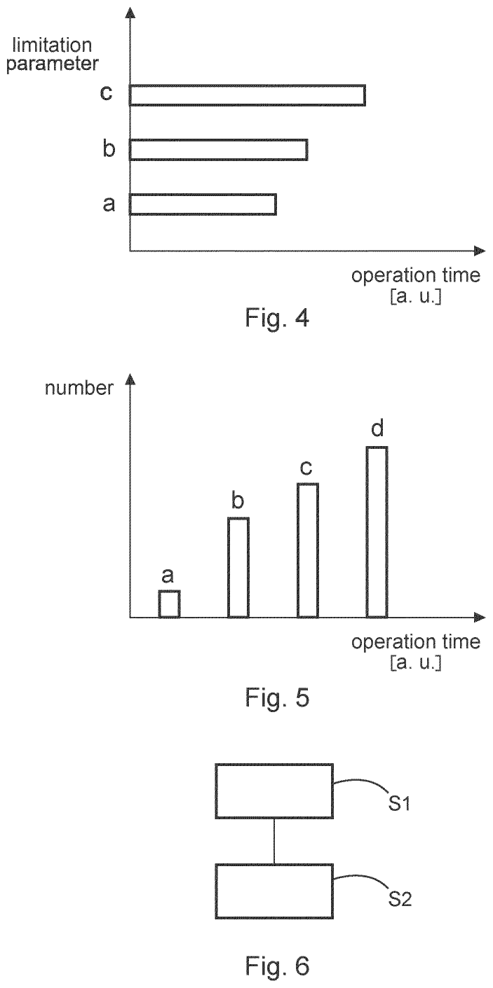

In yet another example, the limitation parameter may be time-based. FIG. 4 shows several limitation parameters a, b, c, in relation to the operation time in arbitrary units. Therein, FIG. 4 illustrates a correlation between the operation time and a corresponding limitation parameter a, b, and c. Therein, the operation time may refer to a time period the device 100 is used for aerosol generation. Alternatively or additionally, the operation time may correlate with a subscribed duration of usage of the aerosol generating device 100. The operation time may be a certain period, for example certain hours, days, weeks, months, or years, that may be set on a counter 115, such as a mechanical counter or an electronic counter, which may be disposed in the aerosol generating device 100. In an example, the aerosol generating device 100 may integrally include the counter 115 to set or to determine the predefined operation time as indicated by the limitation parameters a, b, c.

In another example, the aerosol generating device 100 may remotely communicate with an electronic counter that may be stored at a computing device 500, the mobile device 400 and/or the companion device 300. The electronic counter may determine information associated with a start date of the aerosol generating device 100, an end date of the aerosol generating device 100, optionally a subscription period of the user, and store the determined information at the computing device 500, the mobile device 400 and/or the companion device 300. Based on the determined information, the computing device 500, the mobile device 400 and/or the companion device 300 may remotely disable the aerosol generating device 100 without any further interaction with the aerosol generating device 100 by the user.

For example, the aerosol generating device 100 may be operated with limitation parameter a illustrated in FIG. 4, which may be associated with a first subscription period or first operation time, e.g. for a first level of subscription. Based on a completion of the first subscription period or first operation time indicated by limitation parameter a, the aerosol generating device 100 may be turned off or be deactivated for further use. In order to further switch-on the aerosol generating device 100, the user may update the limitation parameter, for example renew the subscription services of the aerosol generating device 100. The aerosol generating device 100 may be configured to enable or disable the usage of the based on the limitation parameter, which may be saved as predefined maximum operation time in the counter 115 and/or a data storage 114 of the aerosol-generating device 100.

In another example, the aerosol generating device 100 may be operated with limitation parameter b illustrated in FIG. 4, which may be associated with a second subscription period or second operation time. The second operation time may be longer than the first operation time. Based on a completion of the second operation time, the aerosol generating device 100 may turn off. In order to further switch-on or enable the aerosol generating device 100, the user may update the limitation parameter, for example renew the subscription services of the aerosol generating device 100.

In another example, the aerosol generating device 100 may be operated with limitation parameter c illustrated in FIG. 4, which may be associated with a third subscription period or third operation time. The third operation time may be longer than the first and second operation times. Based on a completion of the third operation time, the aerosol generating device 100 may turn off. In order to further switch-on or enable the aerosol generating device 100, the user may update the limitation parameter, for example renew the subscription services of the aerosol generating device 100. Further limitation parameters indicative of further operation time periods may be implemented analogously.

In yet another example, the limitation parameter may be consumption-based or usage-based and time-based. FIG. 5 shows on the y-axis the number of usage sessions, number of aerosol-generating articles 200, number of inhalations and/or any other countable quantity representative of the aerosol generation using the device 100. The x-axis of FIG. 5 shows the operation time in arbitrary units. Both operational parameter parameters, i.e. a predefined number and a predefined operation time, may be defined by one or more limitation parameters a, b, c, d applied by the device 100 to limit use thereof for aerosol generation. Each bar in FIG. 5 may represent a particular limitation parameter a, b, c, d, which may optionally be associated with different levels of subscription.

Based on which the limitation parameter a, b, c, d is activated in the device 100, the time period and the maximum number of one or more of usage sessions, inhalations and aerosol-generating articles may vary. For example, limitation parameter a may define an operation time of one week, and a maximum number of 20 usage sessions may be allowed during the first operation time. After completion of the maximum number of usage sessions, the user may need to wait for a completion of the first time period or update the limitation parameter, for example to one of parameters b, c, or d. Alternatively or additionally, limitation parameter a may be re-set, for example by re-subscribing to this level. Further, based on the completion of maximum number of usage sessions within the first operation time, the aerosol generating device 100 may turn off or be disabled. In order to further switch-on the aerosol generating device, the user may update the limitation parameter, for example renew the subscription services of the aerosol generating device 100.

In an exemplary configuration, one or more of a time stamp or time of the start of an operation time interval, a duration of the corresponding operation time, and optionally the predefined amount or number of usage sessions, articles and/or inhalations may be transmitted from one or more of the computing device 500, mobile device 400 and the companion device 300 to the aerosol-generating device 100 in the form of one or more limitation parameters. The device control circuitry 110 may decrypt the limitation parameter and store it, for example in a permanent memory or data storage 114, such as the flash memory, and may leverage an internal real time clock to define the actual start and finish time of the operation time or time period. To keep track of the amount or number, for example, usage sessions, the device control circuitry 110 may increase a counter 115, for example a register in a memory or flash memory, and compare its value with the maximum number defined by the limitation parameter before the finish time of the operation time is reached.

As described hereinabove, the limitation parameter may be received by the aerosol-generating device 100 via one or more of the user interface 120, the companion device 300, the mobile device 400 and the computing device 500. Accordingly, usage of the aerosol-generating device 100 may be indirectly controlled via one or more of devices 300, 400, 500. For example, the aerosol-generating device 100 can be coupled to the computing device 500 directly or indirectly via one or more of the mobile device 400 and the companion device 300. One or both the mobile device 400 and the companion device 300 may receive the limitation parameter from the computing device 500 and may optionally submit a lock and/or unlock signal or command to the aerosol-generating device 100, for example through a secure channel using the communication interface 130, for instance a Bluetooth LowEnergy connection.

The unlock command or may instruct the device control circuitry 110 to enable the aerosol-generating device 100 for aerosol generation, while the lock command may prevent aerosol generation. These commands could for instance be used to set a flag, for example 1 or 0, in the data storage 114 of the aerosol-generating device 100. For instance, “1” could be associated with “device lock status” and “0” with “device unlock status”.

Alternatively or additionally, the aerosol-generating device 100 could be locked and/or unlocked by a distribution box publicly available in the street or in a shop where the aerosol-generating device 100 would be unlocked in accordance with the limitation parameter. Alternatively or additionally, usage of the device 100 for aerosol generation may be controlled by a plug-in type of SIM card that may for example include a permanent memory storing the information of the limitation parameter, and optionally a subscription associated therewith. The memory may be accessed by the device control circuitry 110 of the aerosol-generating device 100 to retrieve the limitation parameter, for example to enable the start of a heating sequence or require an additional recharge. Alternatively or additionally, usage of the aerosol-generating device 100 may be controlled by a mobile device 400, companion device 300 and/or computing device 500 based on scratching a scratch-card to make a hidden limitation parameter or corresponding code visible and insert the limitation parameter or code into the respective device 300, 400, 500 to transmit it to the aerosol-generating device 100. The limitation parameter or code may be exchanged an encrypted token and decrypted by the device control circuitry 110 of the aerosol-generating device 100, and optionally stored in the data storage 114.

In an example, the counter 115 of the aerosol-generating device 100, as described hereinabove, may be implemented to allow, inter alia, for a predefined number of usage sessions, aerosol-generating articles 200 and/or inhalations. The predefined number of the limitation parameter may be stored in the data storage 114 or memory of the device, and each time device 100 is used to generate aerosol or inhale aerosol, the respective number stored in the counter 115 may be decreased. When the counter 115 reaches zero, the aerosol-generating device 100 may reject any request of the user for further aerosol generation, as described hereinabove. Vice versa, the counter 115 may be increased and compared to the predefined value indicated by the limitation parameter after each increase.

The counter 115 may optionally be enabled, re-set or reloaded by one or more user inputs at the user interface 120, the companion device 300, the mobile device 400 and the computing device 500.

FIG. 6 illustrates a method of operating an aerosol-generating device 100. The aerosol-generating device 100 may be one of the exemplary aerosol-generating devices 100 described hereinabove, for example with reference to any of FIGS. 1 to 5.

In step S1, a limitation parameter indicative of a limitation to use the aerosol-generating device 100 to generate aerosol is received with a device control circuitry 110 of the aerosol-generating device 100. This may include processing the limitation parameter with the device control circuitry 110.

In step S2, the energy storage 102 of the aerosol-generating device 100 is configured with the device control circuitry 110 based on the limitation parameter, thereby limiting operation of the aerosol-generating device 100 by a user to generate aerosol in accordance with the limitation parameter.

It is noted that any one or more features, functionalities and configurations of the aerosol-generating device 100, as described hereinabove, can be implemented as optional, supplemental or alternative step in the method of FIG. 6.

For the purpose of the present description and of the appended claims, except where otherwise indicated, all numbers expressing amounts, quantities, percentages, and so forth, are to be understood as being modified in all instances by the term “about” or “substantially”. Also, all ranges include the maximum and minimum points disclosed and include any intermediate ranges therein, which may or may not be specifically enumerated herein. In this context, therefore, a number A is understood as A±20% of A. Within this context, a number A may be considered to include numerical values that are within general standard error for the measurement of the property that the number A modifies. Also, all ranges include the maximum and minimum points disclosed and include any intermediate ranges therein, which may or may not be specifically enumerated herein.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims.

In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1.-15. (canceled)

16. An aerosol-generating device, comprising:
device control circuitry and an energy storage configured to supply electrical energy to the device control circuitry for generating aerosol from an aerosol-generating article,
wherein the device control circuitry is configured to:
receive a limitation parameter indicative of a limitation to use the aerosol-generating device to generate aerosol,
control the energy storage based on the limitation parameter, such that operation of the aerosol-generating device by a user to generate aerosol is limited in accordance with the limitation parameter,
determine one or more actual values of one or more operational parameters and compare the one or more actual values to one or more predefined values of the one or more operational parameters indicated by the limitation parameter, and
one or more of terminate a charging cycle of the energy storage, signal completion of a charging cycle, signal an empty energy storage to the user, trigger re-charging of the energy storage, request re-charging of the energy storage, disable the aerosol-generating device for aerosol generation, and enable the aerosol-generating device for aerosol generation based on the comparison,
wherein at least one of the one or more operational parameters is one of a predefined number of usage sessions the aerosol-generating device can be used to generate aerosol, a predefined operation time the aerosol-generating device can be used to generate aerosol, a predefined number of aerosol-generating articles that can be used or consumed with the aerosol-generating device, a predefined number of puffs or inhalations the user can take, a predefined amount of aerosol-generating substrate or article usable with the aerosol-generating device, a predefined range of dates, and an amount of energy drawable from the energy storage for aerosol generation.

17. The aerosol-generating device according to claim 16,
wherein the limitation parameter is indicative of an amount of electrical energy available to the user to generate aerosol, and
wherein the device control circuitry is further configured to control an amount of electrical energy available to the user to generate aerosol based on the limitation parameter.

18. The aerosol-generating device according to claim 16, wherein the limitation parameter is indicative of one or more predefined values for one or more operational parameters associated with operation of the aerosol-generating device to generate aerosol.

19. The aerosol-generating device according to claim 16,
wherein the limitation parameter is indicative of one or more of a predefined output voltage of the energy storage, a predefined charging energy suppliable to the energy storage, a predefined potential energy of the energy storage associated with a change in configuration of internal chemical elements of the energy storage, and a predefined number of charging cycles the energy storage is chargeable, and/or
wherein the device control circuitry is further configured to determine, based on the limitation parameter, one or more of a predefined output voltage of the energy storage, a predefined charging energy suppliable to the energy storage, a predefined potential energy of the energy storage associated with a change in configuration of internal chemical elements of the energy storage, and a predefined number of charging cycles the energy storage is chargeable.

20. The aerosol-generating device according to claim 16, wherein the device control circuitry is further configured to control, based on the limitation parameter, an amount of electrical energy available to the user by controlling charging of the energy storage in one or more charging cycles of the energy storage.

21. The aerosol-generating device according to claim 16,
wherein the limitation parameter is indicative of a maximum charging energy suppliable to the energy storage for charging the energy storage, and
wherein the device control circuitry is further configured to control a charging energy suppliable to the energy storage based on the maximum charging energy indicated by the limitation parameter.

22. The aerosol-generating device according to claim 16, wherein the device control circuitry is further configured to terminate a charging cycle of the energy storage upon determining a charging energy supplied to the energy storage equal to or exceeding a maximum charging energy indicated by the limitation parameter.

23. The aerosol-generating device according to claim 22, wherein the device control circuitry is configured to terminate a charging cycle of the energy storage upon determining one or more of a charging current, a charging time, and a charging voltage of the energy storage equal to or exceeding one or more of a maximum charging current, a maximum charging time, and a maximum charging voltage indicated by the limitation parameter.

24. The aerosol-generating device according to claim 16,
further comprising a data storage storing a plurality of predefined configurations of the energy storage associated with one or more predefined capacity levels of the energy storage,
wherein the device control circuitry is further configured to select one of the plurality of predefined configurations based on the limitation parameter and to configure the energy storage into the selected configuration.

25. The aerosol-generating device according to claim 16,
wherein the limitation parameter is indicative of a maximum number of usage sessions the aerosol-generating device is operable by the user to generate aerosol, and
wherein the device control circuitry is further configured to one or more of disable the energy storage, signal an empty energy storage, trigger re-charging, and request re-charging of the energy storage upon determining a number of usage sessions the aerosol-generating device has been operated to generate aerosol equal to or exceeding the maximum number of usage sessions indicated by the limitation parameter.

26. The aerosol-generating device according to claim 16,
wherein the limitation parameter is indicative of a predefined output voltage of the energy storage, and
wherein the device control circuitry is further configured to measure an output voltage of the energy storage and to compare the measured output voltage of the energy storage to the predefined output voltage indicated by the limitation parameter.

27. The aerosol-generating device according to claim 26, wherein the device control circuitry is further configured to one or more of disable the energy storage, signal an empty energy storage, trigger re-charging, and request re-charging of the energy storage upon determining the measured output voltage of the energy storage being equal to or falling below the predefined output voltage indicated by the limitation parameter.

28. The aerosol-generating device according to claim 16,
wherein the limitation parameter is indicative of a fraction of a maximum amount of energy storable in the energy storage, and
wherein the device control circuitry is further configured to one or more of disable the energy storage, signal an empty energy storage, trigger re-charging, and request re-charging of the energy storage upon determining a decrease in energy stored in the energy storage equal to or above the fraction of the maximum amount of energy storable indicated by the limitation parameter.

29. The aerosol-generating device according to claim 16,
wherein the limitation parameter is indicative of a maximum operation time the aerosol-generating device is operable by the user to generate aerosol, and
wherein the device control circuitry is further configured to one or more of disable the energy storage, signal an empty energy storage, trigger re-charging, and request re-charging of the energy storage upon determining an operation time of the aerosol-generating device equal to or exceeding the maximum operation time indicated by the limitation parameter.

30. The aerosol-generating device according to claim 16, wherein the device control circuitry is further configured to retrieve the limitation parameter from a data storage of the aerosol-generating device, and/or from one or more of a computing device and a companion device communicatively couplable to the aerosol-generating device via a communication interface of the aerosol-generating device.

31. An aerosol-generating system, comprising:
an aerosol-generating device according to claim 16; and
an aerosol-generating article couplable to the aerosol-generating device to generate aerosol from at least a portion of the aerosol-generating article.
